(19) United States
(12) Patent Application Publication
(10) Pub. No.: US 2024/0395097 A1
(43) Pub. Date: Nov. 28, 2024

(54) SYSTEM AND METHOD FOR VENDING MACHINE PRODUCT IDENTIFICATION AND CALIBRATION

(71) Applicant: Crane Payment Innovations, Inc., Malvern, PA (US)

(72) Inventors: Talbert Black, Jr., Lexington, SC (US); Dmytro Baydin, Glenmoore, PA (US); Viralsinh H. Chhasatia, Paoli, PA (US)

(21) Appl. No.: 18/695,750

(22) PCT Filed: Oct. 20, 2022
(86) PCT No.: PCT/US2022/078471

§ 371 Date: Mar. 26, 2024

Related U.S. Application Data
(60) Provisional application No. 63/263,073, filed on Oct. 26, 2021.

(51) Int. Cl. G07F 11/16; G06V 20/52; G07F 9/00

(52) U.S. Cl. CPC G07F 11/16; G06V 20/52; G07F 9/006

(57) ABSTRACT

A system comprises a vending machine. The vending machine includes a product delivery platform operable to retrieve products from a shelf and deposit products into an access port for retrieval. The system also comprises an image capture device operable to capture at least one image of an interior compartment of the vending machine. The system also comprises a vending machine controller coupled to at least one memory. The vending machine controller is configured to receive, based on an image analysis of the at least one image, one or more instructions to update the at least one memory.

### CROSS-REFERENCE TO RELATED APPLICATIONS

This application is a 371 National Stage of International Application No. PCT/US2022/078471, filed Oct. 20, 2022, which claims priority to U.S. Provisional Patent Application No. 63/263,073, filed Oct. 26, 2021, the disclosures of which are incorporated herein by reference.

### TECHNICAL FIELD

The present disclosure is generally directed to vending machines. More specifically, the present disclosure is directed to a system and method for vending machine product identification and calibration.

### BACKGROUND

Vending machines include many complex mechanisms. Today, many vending machines include electronic systems to select, pay, and dispense a product. Also, many vending machines include complex electro-mechanical systems for delivery of the product from a storage location to a customer accessible product retrieval location. These delivery systems in some of the vending machines may not provide a smooth transition of the product from a column to an access port. In particular, the transition of the product from a column to a cup may be rough. Additionally, due to product proliferation in terms of size and shape, the ability to reliably retrieve and deliver a product in a vending machine has become difficult. As such, current vending machines are limited with respect to the types of products that can be vended.

Currently in automated vending machines the shelves that store the product can be installed in various locations. Product types can be loaded into the machine by the route person in various locations. Manufacturing variations can create differences in product location with reference to a “home” position from machine to machine. Additionally, because of manufacturing variations the interface with the delivery location will have variation with reference to a “home” position from machine to machine. Additionally, because of variations in the terrain where a machine is placed and how it is leveled, and other factors such has insulating foam swelling, the delivery location interface can change with reference to a “home” position within an individual machine from the factory to the placement location, and even over time in a single machine at a single placement location. These variations can cause a product delivery mechanism in the vending machine to incorrectly dispense products, such as either failing to move to the correct location to retrieve a product from a shelf, or fail to move to the correct position to dispense the product to a delivery location for customer retrieval.

### SUMMARY

The present disclosure provides a system and method for vending machine product identification and calibration.

In one aspect thereof, a vending machine comprises a chassis, at least one shelf including a plurality of product rows, a plurality of product gates each coupled to an associated one of the plurality of product rows, a movable stage, a retrieval platform coupled to the movable stage, wherein the retrieval platform is operable to move to accept a product from one of the plurality of product rows, and a vending machine controller coupled to at least one memory. The vending machine controller is configured to determine a product code and a storage location of a selected product for vending, retrieve, from the at least one memory, timing parameters associated with at least one of the product code or the storage location of the selected product, and control one or more timings of one of the plurality of product gates associated with the determined storage location of the selected product, based on the retrieved timing parameters, to release the selected product from the at least one shelf to the retrieval platform.

In another aspect thereof, a vending machine comprises a chassis, at least one shelf system including a plurality of product rows, a plurality of product gates each coupled to an associated one of the plurality of product rows, a movable stage, a retrieval platform coupled to the movable stage, wherein the retrieval platform is operable to move to accept a product from one of the plurality of product rows, and a vending machine controller coupled to at least one memory. The vending machine controller is configured to determine a product code and a storage location of a selected product for vending, retrieve, from the at least one memory, timing parameters associated with at least one of the product code or the storage location of the selected product, and control one or more timings of one of the plurality of product gates associated with the determined storage location of the selected product, based on the retrieved timing parameters, to release the selected product from the at least one shelf system to the retrieval platform.

In some embodiments, the timing parameters include parameters for a gate opening speed, a gate open duration, and a gate closing speed.

In some embodiments, to control the one or more timings of the one of the plurality of product gates, the vending machine controller is further configured to modulate one or more pulse width modulation (PWM) signals, wherein each of the one or more PWM signals are associated with one of the gate opening speed, the gate open duration, and the gate closing speed.

In some embodiments, the timing parameters associated with the storage location of the selected product are based on dimensions of the at least one shelf system and an angle of one of the plurality of product rows associated with the storage location of the selected product.

In some embodiments, the timing parameters associated with the product code are based on at least one of shape or weight of a product type associated with the product code.

In some embodiments, the vending machine further comprises a pusher plate mounted on a sidewall of at least one product row of the plurality of product rows, wherein the pusher plate is operable to push products in the at least one product row towards an end of the at least one product row.

In some embodiments, the end of the at least one product row is associated with a retrieval location of the retrieval platform.

In some embodiments, the retrieval platform includes a surface disposed at a base of the retrieval platform, and wherein the retrieval platform is operable to rotate in a direction of the at least one shelf system when the movable stage positions the retrieval platform in relation to one of the plurality of product rows.

In some embodiments, each of the plurality of product gates includes a release mechanism operable to release a product from the associated one of the plurality of product rows when, due to the rotation of the retrieval platform, the surface of the retrieval platform depresses the release mechanism.

In some embodiments, an angle of the retrieval platform, when the retrieval platform rotates in the direction of the at least one shelf system, matches an angle of at least one of the plurality of product rows.

In another aspect thereof, a method of dispensing a product from a vending machine comprises receiving data on a selected product for vending, determining a product code and a storage location of a selected product for vending, retrieving timing parameters associated with at least one of the product code or the storage location of the selected product, moving a retrieval platform coupled to a moveable stage to a position to accept the selected product from one of a plurality of product rows of at least one shelf system of the vending machine, and controlling one or more timings of one of a plurality of product gates associated with the determined storage location of the selected product, based on the retrieved timing parameters, to release the selected product from the at least one shelf system to the retrieval platform, wherein each of the plurality of product gates are coupled to an associated one of the plurality of product rows.

In some embodiments, the timing parameters include parameters for a gate opening speed, a gate open duration, and a gate closing speed.

In some embodiments, controlling the one or more timings of the one of the plurality of product gates includes modulating one or more pulse width modulation (PWM) signals, wherein each of the one or more PWM signals are associated with one of the gate opening speed, the gate open duration, and the gate closing speed.

In some embodiments, the timing parameters associated with the storage location of the selected product are based on dimensions of the at least one shelf system and an angle of one of the plurality of product rows associated with the storage location of the selected product.

In some embodiments, the timing parameters associated with the product code are based on at least one of shape or weight of a product type associated with the product code.

In some embodiments, the method further comprises pushing, with a pusher plate mounted on a sidewall of at least one product row of the plurality of product rows, products in the at least one product row towards an end of the at least one product row.

In some embodiments, the end of the at least one product row is associated with a retrieval location of the retrieval platform.

In some embodiments, the retrieval platform includes a surface disposed at a base of the retrieval platform, and further comprising rotating the retrieval platform in a direction of the at least one shelf system when the movable stage positions the retrieval platform in the position to accept the selected product.

In some embodiments, the method further comprises depressing, by the surface of the retrieval platform when the retrieval platform rotates, a release mechanism of one of the plurality of product gates to release a product from the associated one of the plurality of product rows.

In some embodiments, an angle of the retrieval platform, when the retrieval platform rotates in the direction of the at least one shelf system, matches an angle of at least one of the plurality of product rows.

In another aspect thereof, an operator can take picture of a vending machine product placement after arranging products in product locations using a camera. The camera sends picture or pictures to a remote computer. The remote computer identifies products with location. The remote computer fetches at least one timing parameter such as a gate opening speed, a gate open duration, and a gate closing speed associated with that particular product and sends those timing parameters to the vending machine.

In some embodiments, the camera sends a picture or pictures to the vending machine. The vending machine carries out image processing and identifies product in pictures. The vending machine associates identified product with a particular location. The vending machine queries the remote computer for dispensing parameters. The remote computer sends dispensing parameters to the vending machine. The vending machine updates dispensing parameters for the identified product.

In some embodiments, the vending machine carries out image processing and identifies product in pictures. The vending machine associates identified product with a particular location. The vending machine fetches dispensing parameters for identified product. The vending machine updates dispensing parameters for the identified product.

In some embodiments, a processor enclosed in same enclosure as the camera carries out image processing and identifies product in pictures. The processor enclosed in the same envelope as the camera also associates identified product with a particular location. The processor enclosed in the same envelope as the camera fetches dispensing parameters for the identified product. The processor enclosed in the same envelope as the camera transmits dispensing parameters to the vending machine.

In some embodiments, the operator inserts new dispensing parameters for identified product in the pictures.

In some embodiments, the operator modifies dispensing parameters for identified product in the pictures.

In some embodiments, the remote computer also sends the product location to the vending machine.

In some embodiments, the remote computer can also send timing parameters for all product locations.

In some embodiments, a camera mounted on X-Y platform can take pictures of vending machine product placement after products the vending machine have been arranged in designated product locations. The vending machine carries out image processing and identifies product in pictures. The vending machine associates identified product with a particular location. The vending machine queries the remote computer for dispensing parameters. The remote computer sends dispensing parameters to the vending machine. The vending machine updates dispensing parameters for the identified product.

In some embodiments, the vending machine sends images to a remote computer for image processing and product identification. The remote computer identifies products with location. The remote computer fetches at least one timing parameter such as a gate opening speed, a gate open duration, and a gate closing speed associated with that particular product and sends those timing parameters to the vending machine.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. The phrase “at least one of,” when used with a list of items, means that different combinations of one or more of the listed items may be used, and only one item in the list may be needed. Definitions for certain words and phrases are provided throughout this patent document, those of ordinary skill in the art should understand that in many, if not most instances, such definitions apply to prior, as well as future uses of such defined words and phrases.

The terms “transmit,” “receive,” and “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure, reference is now made to the following description, taken in conjunction with the accompanying drawings, in which:

FIG. 1 illustrates a simplified perspective view of a vending machine according to embodiments of the present disclosure;

FIGS. 2A and 2B illustrate examples of a simplified perspective view illustrating a vending machine implementing a plurality of release mechanisms each for a plurality of gates according to embodiments of the present disclosure;

FIGS. 3A and 3B illustrate views of a platform according to embodiments of the present disclosure;

FIGS. 3C and 3D illustrate views of another platform according to embodiments of the present disclosure;

FIGS. 3E and 3F illustrate views of another platform according to embodiments of the present disclosure;

FIG. 4A illustrates a platform in a position to receive a product from a product tray according to embodiments of the present disclosure;

FIG. 4B illustrates a platform in receipt of a product from a product tray according to embodiments of the present disclosure;

FIG. 5A illustrates a side view of a platform apparatus in an initial position according to embodiments of the present disclosure;

FIG. 5B illustrates a rear perspective view of a platform apparatus in an initial position according to embodiments of the present disclosure;

FIG. 5C illustrates a rear perspective view of a platform apparatus in an initial position with a bottom cover removed exposing a motor according to embodiments of the present disclosure;

FIG. 5D illustrates a cross sectional view of a platform apparatus in an initial position according to embodiments of the present disclosure;

FIG. 5E illustrates a side view of a platform apparatus in a mid-way position according to embodiments of the present disclosure;

FIG. 5F illustrates a cross sectional view of a platform apparatus in a mid-way position according to embodiments of the present disclosure;

FIG. 5G illustrates a side view of a platform apparatus in a retrieval position according to embodiments of the present disclosure;

FIG. 5H illustrates a rear perspective view of a platform apparatus in a retrieval position according to embodiments of the present disclosure;

FIG. 5I illustrates a cross sectional view of a platform apparatus in a retrieval position according to embodiments of the present disclosure;

FIG. 5J illustrates a rear perspective view of a platform apparatus in a product ejection position according to embodiments of the present disclosure;

FIG. 6A illustrates a front perspective view of a product retrieval mechanism in a closed position according to embodiments of the present disclosure;

FIG. 6B illustrates a side view of a product retrieval mechanism in a closed position according to embodiments of the present disclosure;

FIG. 6C illustrates a front perspective view of a product retrieval mechanism in an open position according to embodiments of the present disclosure;

FIG. 6D illustrates a side view of a product retrieval mechanism in an open position according to embodiments of the present disclosure;

FIG. 7A illustrates a side view of a platform apparatus in an initial position before interacting with a product retrieval mechanism according to embodiments of the present disclosure;

FIG. 7B illustrates a side view of a platform apparatus in product retrieval position interacting with a product retrieval mechanism according to embodiments of the present disclosure;

FIG. 8A illustrates a rear view of a platform apparatus positioned above a discharge frame according to embodiments of the present disclosure;

FIG. 8B illustrates a rear view of a platform apparatus engaging a discharge frame according to embodiments of the present disclosure;

FIG. 9 illustrates a side mounted damper assembly according to embodiments of the present disclosure;

FIG. 10A illustrates a front perspective view of a shelf system according to embodiments of the present disclosure;

FIG. 10B illustrates an enlarged view of a portion of the shelf system according to embodiments of the present disclosure;

FIG. 10C illustrates a side perspective view of a product gate of a shelf system according to embodiments of the present disclosure;

FIG. 11 illustrates a flowchart of a variable retrieval speed process according to embodiments of the present disclosure;

FIG. 12 illustrates an example vending machine variable timing system in accordance with various embodiments of this disclosure;

FIGS. 13A and 13B illustrate an example of a product delivery mechanism with a correct shelf offset in accordance with various embodiments of this disclosure;

FIGS. 14A and 14B illustrate an example of a product delivery mechanism with an incorrect shelf offset in accordance with various embodiments of this disclosure;

FIGS. 15A and 15B illustrate an example of a product delivery mechanism with an incorrect shelf offset in accordance with various embodiments of this disclosure;

FIGS. 16A-16C illustrate an example of a product delivery mechanism with a correct hook offset in accordance with various embodiments of this disclosure;

FIGS. 17A and 17B illustrate an example of a product delivery mechanism with an incorrect hook offset in accordance with various embodiments of this disclosure;

FIGS. 18A and 18B illustrate an example of a product delivery mechanism with an incorrect hook offset in accordance with various embodiments of this disclosure;

FIG. 19 illustrates a vending machine monitoring and image capture system in accordance with various embodiments of this disclosure;

FIG. 20 illustrates a product identification and product delivery mechanism calibration process in accordance with various embodiments of this disclosure;

FIG. 21 illustrates a product identification and gate timing parameters process in accordance with various embodiments of this disclosure;

FIG. 22 illustrates a product identification and gate timing parameters process in accordance with various embodiments of this disclosure;

FIG. 23 illustrates a product identification and gate timing parameters process in accordance with various embodiments of this disclosure;

FIG. 24 illustrates a product identification and gate timing parameters process in accordance with various embodiments of this disclosure;

FIG. 25 illustrates a product identification and gate timing parameters process in accordance with various embodiments of this disclosure; and

FIG. 26 illustrates an example electronic device in accordance with various embodiments of this disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. The phrase “at least one of,” when used with a list of items, means that different combinations of one or more of the listed items may be used, and only one item in the list may be needed. Definitions for certain words and phrases are provided throughout this patent document, those of ordinary skill in the art should understand that in many, if not most instances, such definitions apply to prior, as well as future uses of such defined words and phrases.

### DETAILED DESCRIPTION

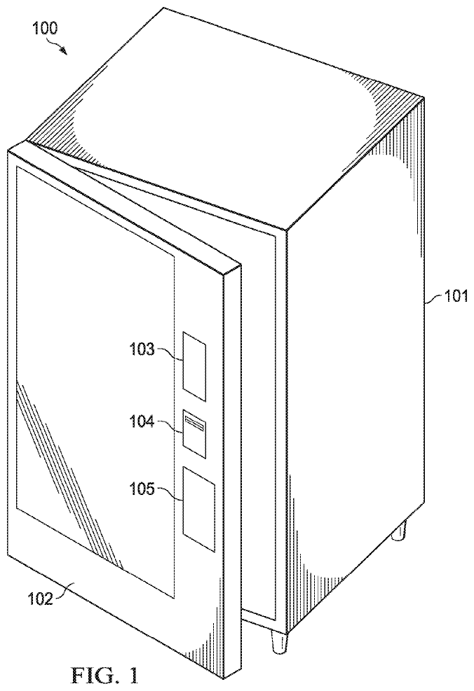

FIGS. 1 through 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device or system.

FIG. 1 illustrates a simplified perspective view of a vending machine 100 according to embodiments of the present disclosure. Vending machines come in a wide variety of configurations, and FIG. 1 does not limit the scope of the present disclosure to any particular implementation of a vending machine.

Vending machine 100 includes a chassis or cabinet 101 and a service door 102 that, together, define an enclosure. In the embodiment illustrated in FIG. 1, the service door 102 is pivotally mounted to the front of the cabinet 101 and extends all the way across the front face of the vending machine 100. In alternate embodiments, the service door may extend only part way across the front of the vending machine, or may be formed in two portions (of equal or unequal sizes) that swing open in opposite directions. In alternate embodiments, the service door may slide open and allow customer to access products. In alternate embodiments, the vending machine may not have a service door.

In the embodiment illustrated in FIG. 1, the service door 102 includes a customer user interface 103, illustrated as a touch screen liquid crystal display (LCD) display. A payment system 104 is mounted within the service door 102 and includes one or more of a bill validator, a coin acceptor and/or a credit or debit card reader. The payment system 104 receives currency, coins or other forms of payment from the customer and returns change as necessary. FIG. 1 also depicts an access port 105 to a delivery receptacle mounted within the service door 102 or in the cabinet 101. The access port 105 may have a delivery door or other mechanical system (e.g., rotatable delivery receptacle open on one side) for controlling or restricting access by the customer into the delivery receptacle, the interior of the vending machine, or both. Those skilled in the art will recognize that in some vending machines, particularly helical coil snack vending machines, the access port 105 may be located near the bottom of the vending machine and extend across most of the width of the machine, below a large glass window allowing the contents within the cabinet to be viewed or a large liquid crystal display selectively presenting images of products available for vending or advertisements. Other vending machines, in particular beverage vending machines, have X-Y product retrieval and delivery mechanisms and a glass front or large liquid crystal display, but may include an access port 105 to the side as shown in FIG. 1, at a height convenient to the customer for product retrieval.

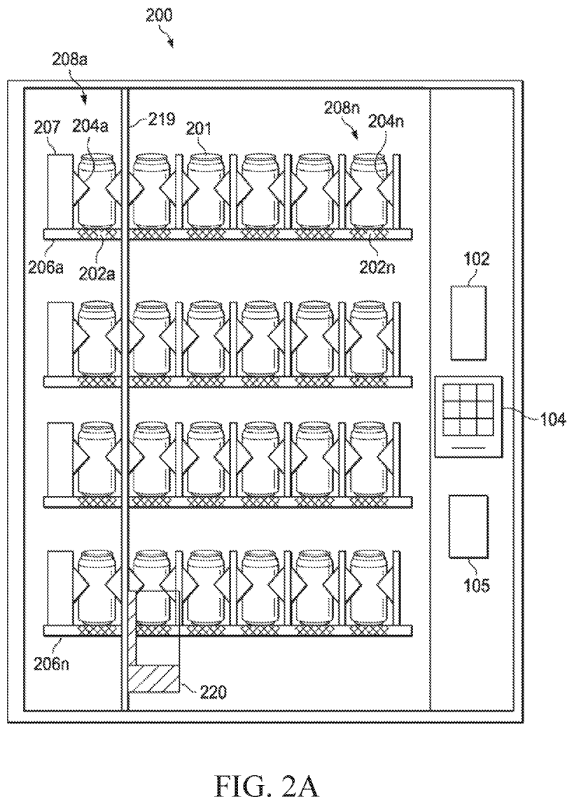

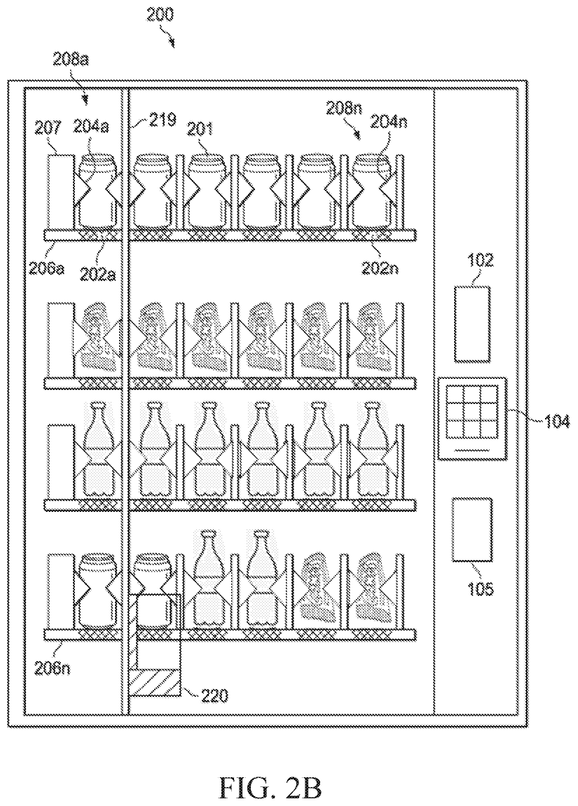

FIGS. 2A and 2B illustrate examples of a simplified perspective view illustrating a vending machine 200 implementing a plurality of release mechanisms 202a . . . 202n each for a plurality of gates 204a . . . 204n according to embodiments of the present disclosure. Vending machines come in a wide variety of configurations, and FIGS. 2A and 2B does not limit the scope of the present disclosure to any particular implementation of a vending machine. The components of the vending machine 200 could be used with the vending machine 100 as shown in FIG. 1.

The vending machine cabinet 101 houses a plurality of product trays 206a . . . 206n, each including a plurality of product columns 208a, 208b . . . 208n. For every product column 208a, there is at least one gate 204a. The plurality of gates 204a . . . 204n may be, but not limited to, double gates (as shown in FIGS. 2A and 2B with one gate on each side of the product 201), cylindrical barriers, bars, rotational containers, and other types of barriers. The gates may be connected to a sidewall, such as sidewall 207.

In certain embodiments, for each gate 204a, there may be a release mechanism 202a. The release mechanism 202a can be manual or automatic. For example, release mechanism 202a can be motor with a gearbox, a knob, a lever, a solenoid, or some other suitable device. During a purchase of a product 201, the release mechanism 202a may interact with gate 204a that is restraining the product 201 located in column 208a. The release mechanism may interact with one or more gates that restrain products in a column. The interaction may allow the product 201 to move past gate 204a. The release mechanism 202a can be activated by a platform 220.

In certain embodiments, for each tray 206a, there is a release mechanism 202a. At each column, release mechanism 202a can release a product by interacting with a gate. As shown in this example embodiment, platform 220 is coupled to a movable stage 219 and is configured to move to a product via the movable stage 219 for vending of the product. In response to a user selection and a vend command, the movable stage 219 moves horizontally to a location associated with a product column 208a, 208b . . . 208n, and platform 220 moves vertically along the movable stage 219 to a product to collect the product by activating the release mechanism 202a and capturing the product once released from the column. The platform 220 then moves to and dispenses the product into access port 105 for customer retrieval. In some embodiments, as shown in FIG. 2B, a variety of products having different packaging and shapes can be included in the vending machine.

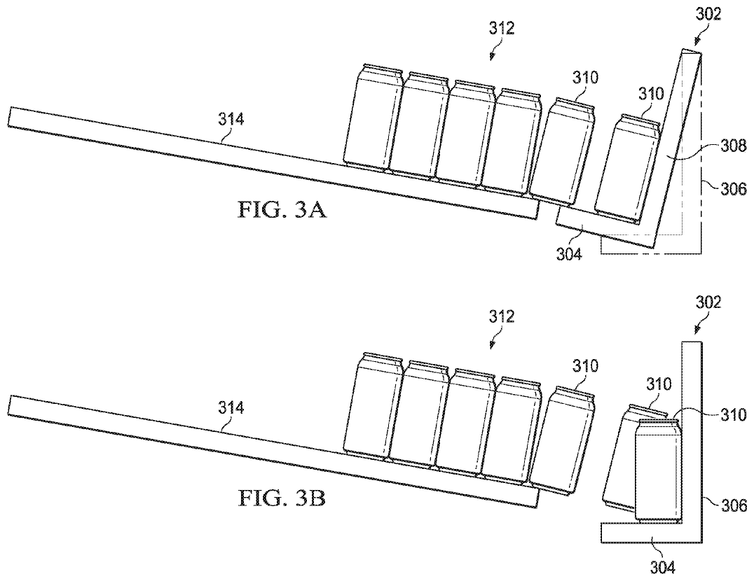

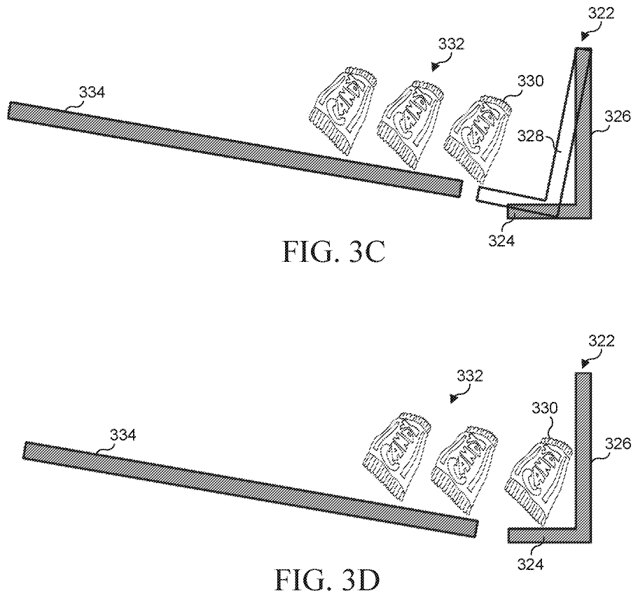

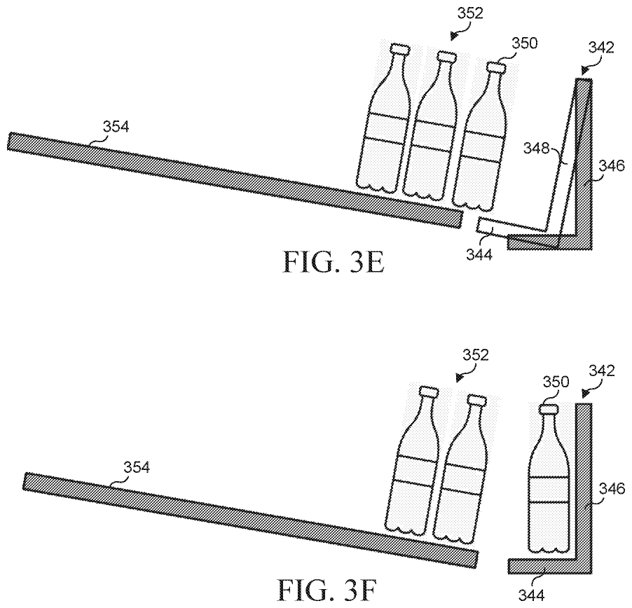

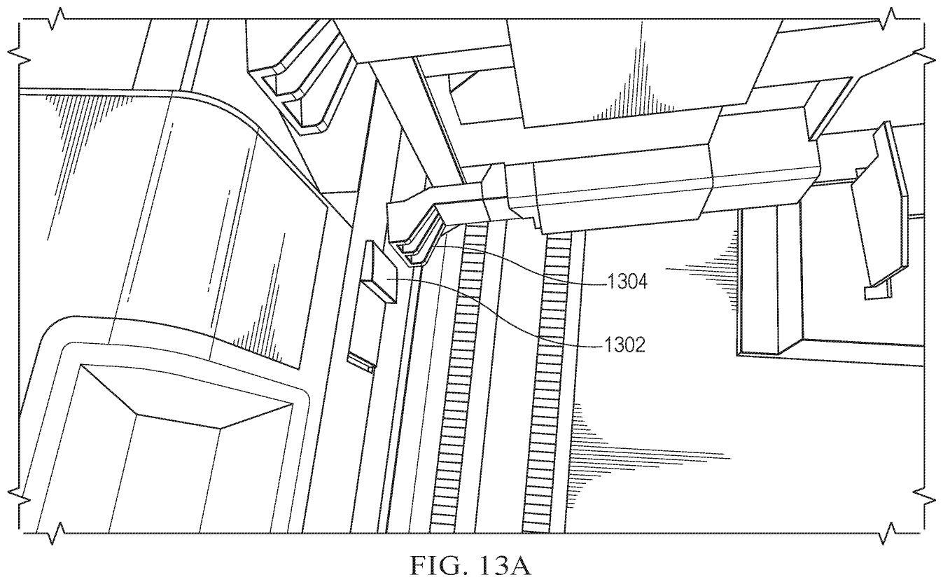

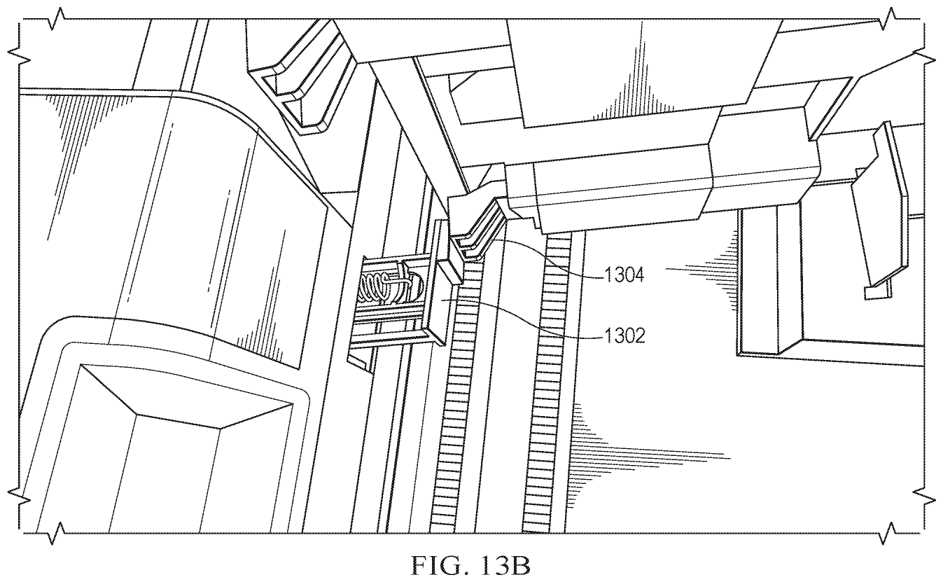

FIGS. 3A-3F illustrate various views of a platforms according to embodiments of the present disclosure. Platforms can come in a wide variety of configurations, and FIGS. 3A-3F do not limit the scope of the present disclosure to any particular implementation of a platform. For example, the platform could be a tilting platform that tilts to receive a product from a product tray, or a non-tilting platform such as a platform that uses an arm or other dispensing mechanism to release a product from a tray, such as shown in FIGS. 13A-15B. The platforms illustrated could be used with the vending machine 100 as shown in FIG. 1, or the vending machine 200 as shown in FIGS. 2A and 2B.

FIG. 3A illustrates a platform 302 in a product retrieval position according to embodiments of the present disclosure. FIG. 3B illustrates the platform 302 in an initial position according to embodiments of the present disclosure. FIG. 3C illustrates another platform 322 retrieving a snack and in a product retrieval position according to embodiments of the present disclosure. FIG. 3D illustrates the platform 322 of FIG. 3C in an initial position according to embodiments of the present disclosure. FIG. 3E illustrates another platform 342 retrieving a bottle and in a product retrieval position according to embodiments of the present disclosure. FIG. 3F illustrates the platform 342 of FIG. 3E in an initial position according to embodiments of the present disclosure.

As illustrated in FIGS. 3A and 3B, the platform 302 has a shelf or “L” bracket that can be referred to as a base 304 of the platform 302. The platform 302 can tilt out from an initial position 306 to a tilted position 308 to accept a product 310 from a plurality of products 312 included on a product tray 314. The initial position 306 can be, for example, a vertical position (as shown in FIGS. 2A and 2B). The platform 302 can be more stable and follow a path of motion of the falling product 310. To move the base 304 of the platform 302 into the tilted position 308, the base 304 can move out towards the product tray 314 into the tilted position 308. The tilted position 308 can also be referred to as a receiving position.

In some vending machine systems, when receiving a product, such as a canned drink, as shown for example in FIGS. 3A and 3B, from a column or a product tray into a non-platform or dispenser having a horizontal base, the product may tilt or bridge. Bridging occurs when the top of a product tilts during the vending process and is unable to move from the tray into the dispenser. The top of the product is in the dispenser and the bottom of the product remains in the tray, “bridging” the gap between the two. Tilting and bridging lead to failed product exchanges from the tray to the dispenser. Tilting and bridging in a non-tilted platform can happen due to the product transitioning from an angled product tray into a horizontal platform base. A tilted platform, such as platform 302, allows the product to follow the path of motion of a falling product (e.g., a can), eliminating the tilting and bridging.

The angle of the base 304 in the tilted position 308 can be similar to that of the angle of the column, or the portion of the column located nearest to the base. This angle of the platform 302 when in the tilted position 308 can cause the base 304 of the platform to be in line with the product tray 314 such that the product 310 can slide straight into the platform 302 without any tilting or bridging of the product 310. When the platform 302 receives the product 310, a base of the product 310 sits atop base 304 of the platform 302, and sides of the product 310 can rest against one or side walls of the platform 302. The platform 302 then returns to the initial position 306 for delivery of the product 310. In some embodiments, the platform 302 travels to or near an access port, such as access port 105, to deposit the product 310 into the access port to allow a user to retrieve the product 310 from the access port 105.

As illustrated in FIGS. 3C and 3D, the platform 322, like the platform 302, includes a shelf or “L” bracket that can be referred to as a base 324 of the platform 322. The platform 322 can tilt out from an initial position 326 to a tilted position 328 to accept a product 330 from a plurality of products 332 included on a product tray 334. The initial position 326 can be, for example, a vertical position (as shown in FIGS. 2A and 2B). The platform 322 can be more stable and follow a path of motion of the falling product 330. To move the base 324 of the platform 322 into the tilted position 328, the base 324 can move out towards the product tray 334 into the tilted position 328. The tilted position 328 can also be referred to as a receiving position.

In some vending machine systems, when receiving a product, such as a less rigid product such as a food item packaged in a bag or plastic wrapping, such as shown for example in FIGS. 3C and 3D, from a column or a product tray into a non-tilting platform or dispenser having a horizontal base, the product may tilt, bridge, or otherwise fall over. Tilting and bridging lead to failed product exchanges from the tray to the dispenser. Tilting and bridging in a non-tilted platform can happen due to the product transitioning from an angled product tray into a horizontal platform base. Although bagged or other packaged food items can have different weights, dimensions, and characteristics, the various embodiments of the present disclosure provide for gates that, in a closed position, hold products and then suddenly release and drop the products into a dispensing mechanism such as the tilted platform 322, allowing products to slide straight into the dispensing mechanism. A tilted platform, such as platform 322, allows the product to follow the path of motion of a falling product (e.g., a bag), eliminating the tilting and bridging.

The angle of the base 324 in the tilted position 328 can be similar to that of the angle of the column, or the portion of the column located nearest to the base. This angle of the platform 322 when in the tilted position 328 can cause the base 324 of the platform to be in line with the product tray 334 such that the product 330 can slide straight into the platform 322 without any tilting or bridging of the product 330. When the platform 322 receives the product 330, a base of the product 330 sits atop base 324 of the platform 322, and sides of the product 330 can rest against one or side walls of the platform 322. The platform 322 then returns to the initial position 326 for delivery of the product 330. In some embodiments, the platform 322 travels to or near an access port, such as access port 105, to deposit the product 330 into the access port to allow a user to retrieve the product 330 from the access port 105.

As illustrated in FIGS. 3E and 3F, the platform 342, like the platforms 302 and 322, includes a shelf or “L” bracket that can be referred to as a base 344 of the platform 342. The platform 342 can tilt out from an initial position 346 to a tilted position 348 to accept a product 350 from a plurality of products 352 included on a product tray 354. The initial position 346 can be, for example, a vertical position (as shown in FIGS. 2A and 2B). The platform 342 can be more stable and follow a path of motion of the falling product 350. To move the base 344 of the platform 342 into the tilted position 348, the base 344 can move out towards the product tray 354 into the tilted position 348. The tilted position 348 can also be referred to as a receiving position.

In some vending machine systems, when receiving a product, such as product with non-uniform weight distribution, such as a bottle having a heavier bottom portion than the top elongated bottle neck portion, such as shown for example in FIGS. 3E and 3F, from a column or a product tray into a non-platform or dispenser having a horizontal base, the product may tilt, bridge, or otherwise fall over. Tilting and bridging lead to failed product exchanges from the tray to the dispenser. Tilting and bridging in a non-tilted platform can happen due to the product transitioning from an angled product tray into a horizontal platform base. Although bottled items can have different weights, dimensions, and characteristics, the various embodiments of the present disclosure provide for gates that, in a closed position, hold products and then suddenly release and drop the products into a dispensing mechanism such as the tilted platform 342, allowing products to slide straight into the dispensing mechanism. A tilted platform, such as platform 342, allows the product to follow the path of motion of a falling product (e.g., a bottle), eliminating the tilting and bridging.

The angle of the base 344 in the tilted position 348 can be similar to that of the angle of the column, or the portion of the column located nearest to the base. This angle of the platform 342 when in the tilted position 348 can cause the base 344 of the platform to be in line with the product tray 354 such that the product 350 can slide straight into the platform 342 without any tilting or bridging of the product 350. When the platform 342 receives the product 350, a base of the product 350 sits atop base 344 of the platform 342, and sides of the product 350 can rest against one or side walls of the platform 342. The platform 342 then returns to the initial position 346 for delivery of the product 350. In some embodiments, the platform 342 travels to or near an access port, such as access port 105, to deposit the product 350 into the access port to allow a user to retrieve the product 350 from the access port 105.

In some vending machine systems, when receiving a product, such as product with non-uniform weight distribution, such as a box having a heavier side portion than rest of the box, such as a salad dressing on a side of a box or a meal box with salad and say a sandwich on separate side of a box, from a column or a product tray into a non-platform or dispenser having a horizontal base, the product may tilt, bridge, or otherwise fall over. Tilting and bridging lead to failed product exchanges from the tray to the dispenser. Tilting and bridging in a non-tilted platform can happen due to the product transitioning from an angled product tray into a horizontal platform base. Although bottled items can have different weights, dimensions, and characteristics, the various embodiments of the present disclosure provide for gates that, in a closed position, hold products and then suddenly release and drop the products into a dispensing mechanism such as the tilted platform 342, allowing products to slide straight into the dispensing mechanism. A tilted platform, such as platform 342, allows the product to follow the path of motion of a falling product (e.g., a box), eliminating the tilting and bridging.

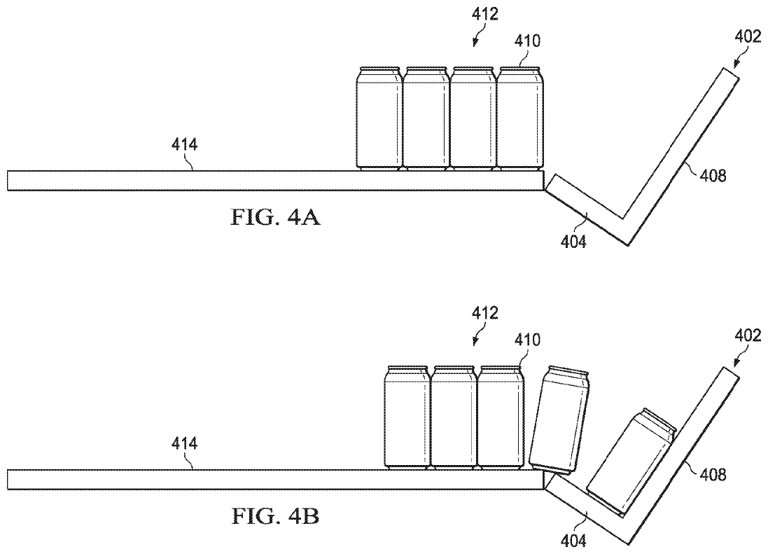

FIGS. 4A and 4B illustrate a platform 402 according to embodiments of the present disclosure. Platforms can come in a wide variety of configurations, and FIGS. 4A and 4B do not limit the scope of the present disclosure to any particular implementation of a platform. For example, the platform could be a tilting platform that tilts to receive a product from a product tray, or a non-tilting platform such as a platform that uses an arm or other dispensing mechanism to release a product from a tray, such as shown in FIGS. 13A-15B. The platform 402 could be used with the vending machine 100 as shown in FIG. 1, or the vending machine 200 as shown in FIGS. 2A and 2B.

FIG. 4A illustrates a platform 402 in a position to receive a product from a product tray according to embodiments of the present disclosure. FIG. 4B illustrates a platform 402 in receipt of a product from a product tray according to embodiments of the present disclosure.

The platform 402 has a shelf or “L” bracket that can be referred to as a base 404 of the platform 402. The platform 402 can tilt out from an initial position (not shown) to a tilted position 408 to accept a product 410 from a plurality of products 412 included on a product tray 414. The initial position can be, for example, a vertical position (such as shown in FIGS. 2 and 3B). To move the base 404 of the platform 402 into the tilted position 408, the base 404 can move out towards the product tray 414 into the tilted position 408. The tilted position 408 can also be referred to as a receiving position according to the present disclosure.

The angle of the base 404 in the tilted position 408 in some embodiments can be lower than that of the angle of the column and product tray 414, or the portion of the column located nearest to the base. For example, the angle of the base 404 can be near 45 degrees from the product tray 414, as shown in FIGS. 4A and 4B. This angle of the platform 402 when in the tilted position 408 causes the product 410 to fall into the platform without any tilting of the top of the product 410 against the platform 402 or any bridging of the product 410. The platform 402 then can return to the initial position for delivery of the product. In some embodiments, the platform 402 travels to near an access port, such as access port 105, to deposit the product 410 into the access port to allow a user to retrieve the product 410. It will be understood that other titled platforms disclosed herein such as tilted platforms 322 and 342 can also move to a position similar to tilted position 408 as shown in FIGS. 4A and 4B, depending on the needs of the system and the types of products to be dispensed, such as bagged food items or bottled drink items.

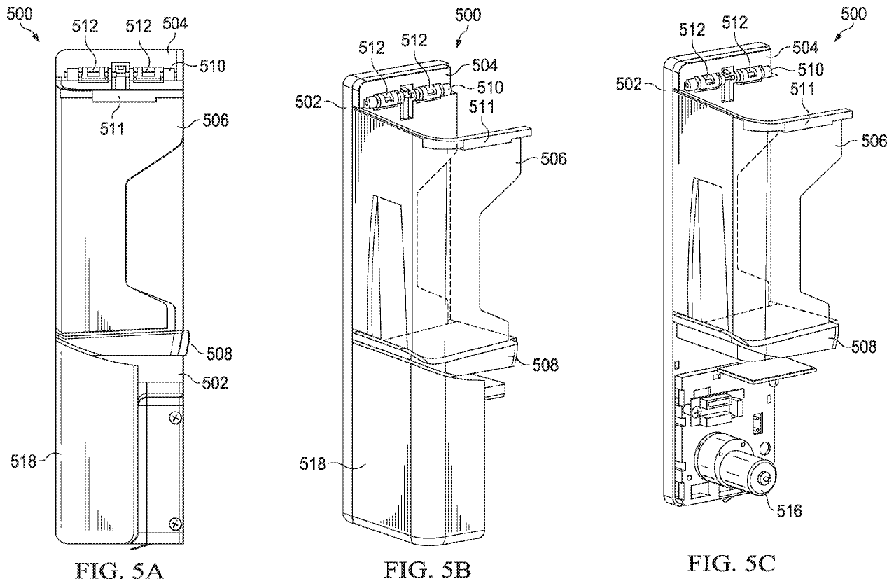

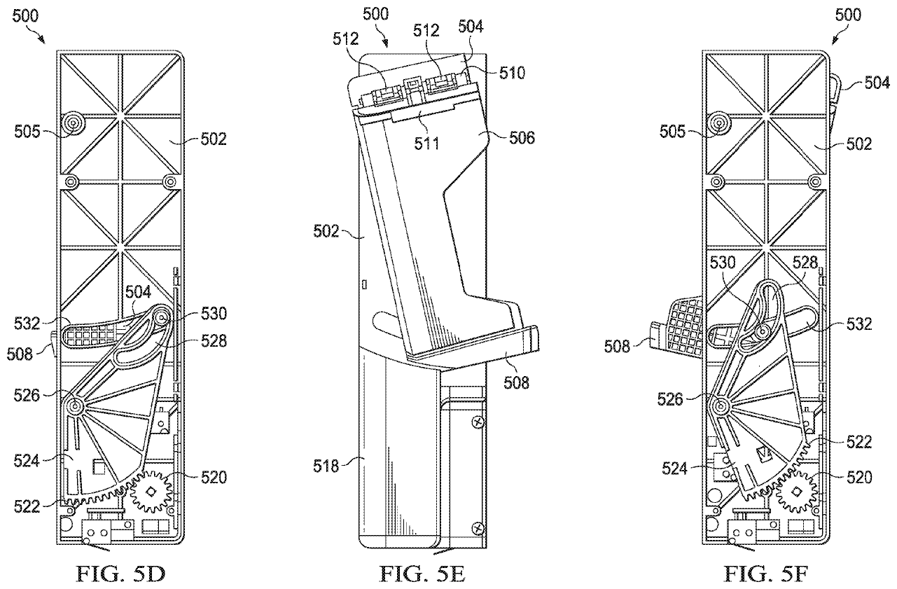

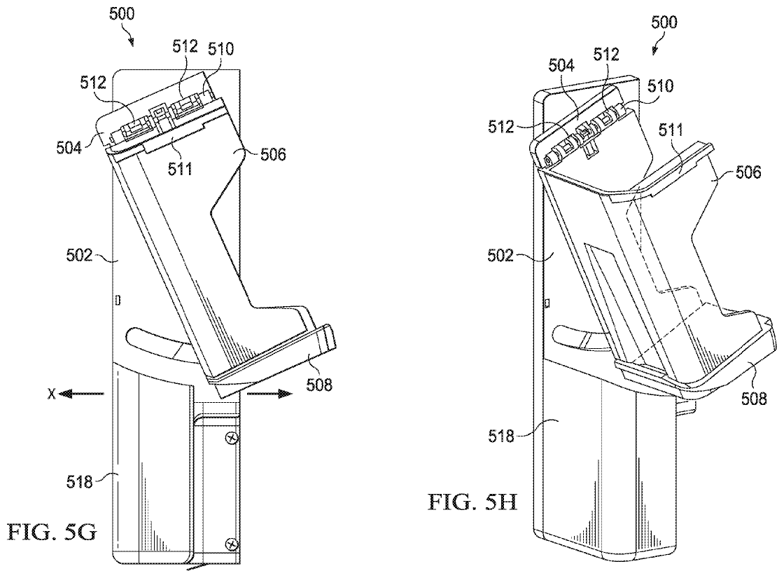

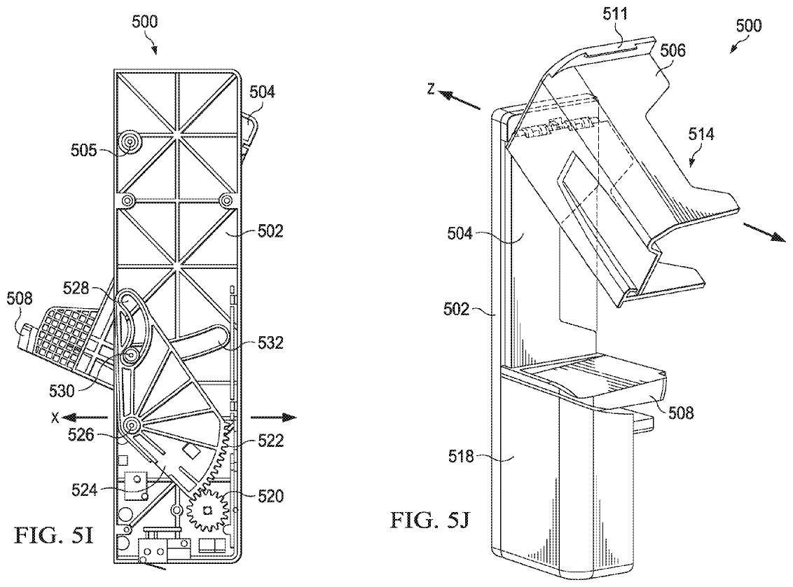

FIGS. 5A-5J illustrate a platform apparatus 500 according to embodiments of the present disclosure. Platform apparatuses can come in a wide variety of configurations, and FIGS. 5A-5J do not limit the scope of the present disclosure to any particular implementation of a platform apparatus. The platform apparatus 500 could be used with the vending machine 100 as shown in FIG. 1, or the vending machine 200 as shown in FIGS. 2A and 2B.

FIG. 5A illustrates a side view of the platform apparatus 500 in an initial position, FIG. 5B illustrates a rear perspective view of the platform apparatus 500 in the initial position, FIG. 5C illustrates a rear perspective view of the platform apparatus 500 in the initial position with a bottom cover removed exposing a motor; and FIG. 5D illustrates a cross sectional view of the platform apparatus 500 in the initial position. FIG. 5E illustrates a side view of the platform apparatus 500 in a mid-way position and FIG. 5F illustrates a cross sectional view of the platform apparatus 500 in the mid-way position. FIG. 5G illustrates a side view of the platform apparatus 500 in a retrieval position, FIG. 5H illustrates a rear perspective view of the platform apparatus 500 in the retrieval position, and FIG. 5I illustrates a cross sectional view of the platform apparatus 500 in the retrieval position. FIG. 5J illustrates a rear perspective view of the platform apparatus 500 in a product ejection position.

The platform apparatus 500 includes a frame 502 on which a plate 504 is rotatably coupled at a pivot point 505. A product catch 506 resides next to the plate 504 with a bottom of the product catch 506 disposed on top of a surface 508. In some embodiments, the frame 502 may be coupled to a movable stage, such as movable stage 219. In some embodiments, the product catch 506 may be directly or indirectly coupled to the movable stage. The connection to the plate 504 can constrain the motion of the surface 508. This allows the product catch 506 to travel with the plate 504 and the surface 508. The product catch 506 can be rectangular in shape with three sides closed and one open side for receiving a product from a tray in a vending machine. The product catch 506 can be transparent in some embodiments to allow a user of the vending machine to see the drink being delivered through the product catch 506. However, in other embodiments, the product catch 506 could be opaque.

The plate 504 includes a hinge 510 near a top of the plate 504. Tabs 512 of the product catch 506 are installed on the hinge 510. A ledge 511 at the top of the product catch 506 opposite the hinge 510 can come into contact with a wall or other component within the vending machine as the platform apparatus travels down towards an access port, such as access port 105. When the ledge 511 comes into contact with a wall or other component in the vending machine the tabs 512 of the product catch 506 rotate around the hinge 510, rotating the product catch 506 out and away from the surface 508 to a product ejection position 514. The product ejection position 514 causes a product to be swept off the surface 508, where a bottom of the product is resting, by the product catch 506 and into an access port, such as access port 105, for retrieval by a user of the vending machine. In other embodiments, the product catch 506 extends out from the frame 502 without rotating, in order to deliver the product to the access port. For example, the product catch 506 can have an extendable arm coupled between the product catch 506 and the frame 502, or another component of the platform apparatus 500. The extendable arm may, by operation of the motor or another mechanism, extend horizontally from the platform apparatus 500 such that the product catch 506 slides sideways, without rotating, off the surface 508 and out over the access port, causing the product to be swept off the surface 508 and into the access port.

The platform apparatus 500 further includes a rotation motor 516 that can be enclosed within a housing 518 in a bottom portion of the platform apparatus 500 that is below the surface 508. The rotation motor 516 rotates a gear 520 that meshes with teeth 522 of a hinged plate 524, as illustrated in FIGS. 5D, 5F, and 5I. The hinged plate 524 includes a pivot point 526 near a front of the platform apparatus 500. The pivot point 526 can be a hole in the hinged plate 524 through which a bolt or other fixation device can be installed. The hinged plate 524 also includes a curved slot 528 near a top of the hinged plate 524 through which another fixation device 530 is installed. The fixation device 530 is also installed through a frame slot 532 of the frame 502 of the platform apparatus 500. The fixation device 530 is connected between the hinged plate 524 and the plate 504 on the other side of the frame 502, with the fixation device 530 traveling through the curved slot 528 of the hinged plate 524 and through the frame slot 532. In some embodiments, the fixation device 530 can be connected to the surface 508.

As the rotation motor 516 rotates the gear 520 meshed with the teeth 522, the hinged plate 524 rotates around the pivot point 526, while the fixation device 530 moves within both the curved slot 528 and the frame slot 532, pushing the plate 504 forward and causing the plate 504 to rotate around the pivot point 505. In other embodiments, the platform apparatus 500 may slide forward instead of rotating. For example, the motor may instead push the surface 508 or the plate 504 forward at or near pivot point 505 or at or near the frame slot 532. For instance, the frame slot 532 may be a horizontal slot rather than a curved slot, with the fixation device 530 sliding forward through the horizontal slot such that the platform moves forward rather than rotating. FIGS. 5A-5D illustrates the plate 504 in an initial position. The initial position allows for a product to rest on the surface 508 and travel with the platform apparatus 500, and the initial position also allows the platform apparatus 500 to travel through a vending machine without coming into contact with other components in the vending machine. The plate 504 rotates from the initial position to a retrieval position, as illustrated in FIGS. 5G-5I, passing a mid-way position as illustrated in FIGS. 5E and 5F. As illustrated in FIG. 5I, to move to the retrieval position, the hinged plate 524 rotates forward, with the teeth 522 traveling across the gear 520 until reaching an end of the teeth 522. At the retrieval position, the surface 508 can contact a release mechanism such as release mechanisms 202a . . . 202n of FIGS. 2A and 2B. Depressing the release mechanism releases a product onto the surface 508. The plate 504 can then be rotated back to the initial position, now holding a product for delivery to a user of the vending machine. The hinged plate 524 provides for product retrieval that is configured to rotate about an X-axis while the hinge 510 rotates about a Z-axis.

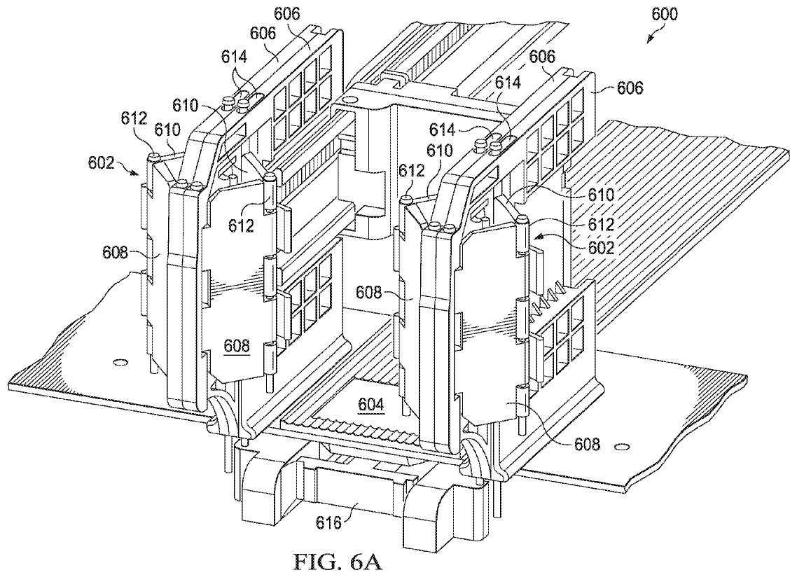

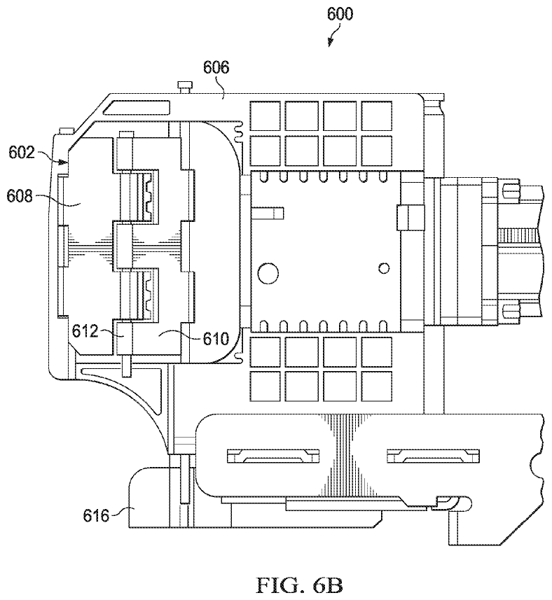

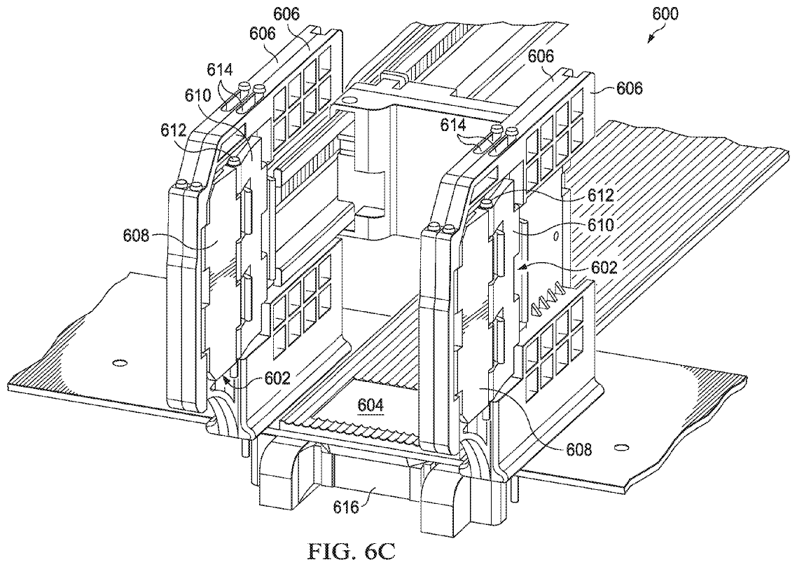

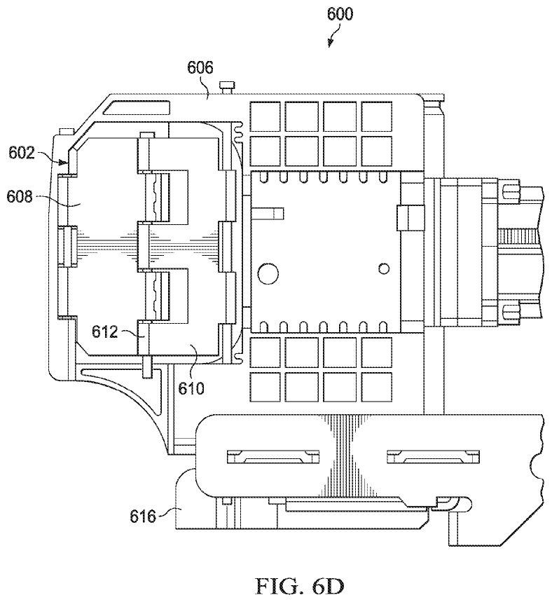

FIGS. 6A-6D illustrate a product retrieval mechanism 600 according to embodiments of the present disclosure. Product retrieval mechanisms can come in a wide variety of configurations, and FIGS. 6A-6D do not limit the scope of the present disclosure to any particular implementation of a product retrieval mechanism. The product retrieval mechanism 600 could be used with the vending machine 100 as shown in FIG. 1, or the vending machine 200 as shown in FIGS. 2A and 2B.

FIG. 6A illustrates a front perspective view of a product retrieval mechanism 600 in a closed position according to embodiments of the present disclosure. FIG. 6B illustrates a side view of the product retrieval mechanism 600 in the closed position according to embodiments of the present disclosure. FIG. 6C illustrates a front perspective view of the product retrieval mechanism 600 in the open position according to embodiments of the present disclosure. FIG. 6D illustrates a side view of the product retrieval mechanism 600 in the open position according to embodiments of the present disclosure.

The product retrieval mechanism 600 includes gates 602. The gates 602 serve to restrict products stored on a product column or a tray 604 from falling off the tray 604. The products can stand in a row between brackets 606, as the products move towards the end of the tray 604. Each of the gates 602 is installed on one of the brackets 606. Each of the gates 602 includes a first panel 608 and a second panel 610 connected by a hinge 612. The first panel 608 can be fixed to the front of one of the brackets 606 and the second panel can be slidably fixed to a top of the bracket through one or more slots 614. A release mechanism 616 (e.g., a button) is disposed in an open space in the tray 604 and below the gates 602 and the brackets 606.

A tilted platform base, such as surface 508 of FIGS. 5A-5J, can depress the release mechanism 616 to open the gates 602. When the release mechanism 616 is depressed (i.e., activated), the gates 602 can move from a closed position shown in FIGS. 6A and 6B to an open position shown in FIGS. 6C and 6D to allow product vending. The gates move between the closed position and the open position by extending down a length of the brackets 606, and through the slots 614, causing the panels 608 and 610 to press inward via the hinge 612 towards the brackets 606 and away from products on the tray 604. Thus, in the open position, the gates 602 flatten, allowing a product to escape and fall into a platform. In various embodiments, the platform can rotate forward to depress the release mechanism 616 and open the gates 602. In various embodiments, a shelf that is moved by a gear can extend outward to activate (i.e., depress) the release mechanism 616. In different embodiments, the mechanism restraining the product can be, in addition to a gate, cylindrical barriers, bars, rotational containers, and other types of barriers.

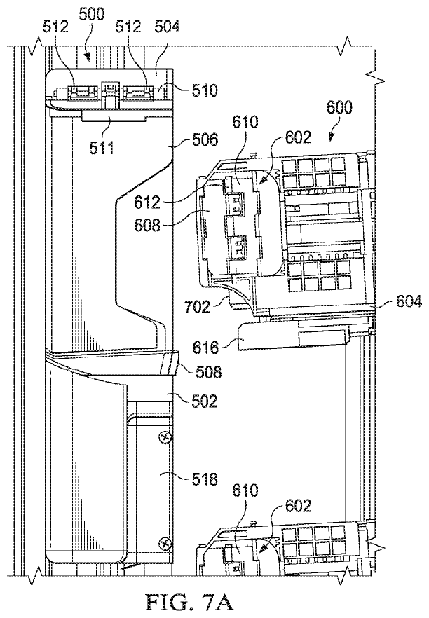

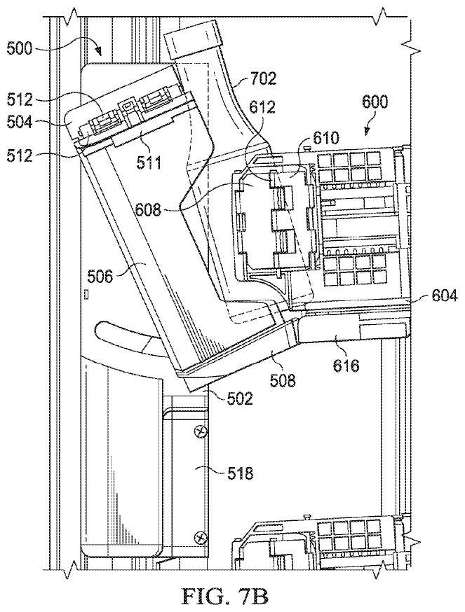

FIGS. 7A and 7B illustrate the platform apparatus 500 interacting with product retrieval mechanism 600 according to embodiments of the present disclosure. Platform apparatuses and product retrieval mechanisms can come in a wide variety of configurations, and FIGS. 7A and 7B do not limit the scope of the present disclosure to any particular implementation of a platform apparatus or product retrieval mechanism. The platform apparatus 500 and the product retrieval mechanism 600 could be used with the vending machine 100 as shown in FIG. 1, or the vending machine 200 as shown in FIGS. 2A and 2B. It should be understood that other titling platforms and product retrieval mechanisms provided by the present disclosure can be substituted into the vending machine illustrated in FIGS. 7A and 7B.

FIG. 7A illustrates a side view of the platform apparatus 500 in an initial position before interacting with the product retrieval mechanism 600 according to embodiments of the present disclosure. FIG. 7B illustrates a side view of the platform apparatus 500 in product retrieval position interacting with the product retrieval mechanism 600 according to embodiments of the present disclosure.

As illustrated in FIG. 7A, the platform apparatus 500 in the initial position can move in front of a tray 604 containing one or more products 702. The one or more products 702 can be held on the tray 604 by the gates 602. As illustrated in FIG. 7B, when the plate 504 is rotated against the frame 502 as described in the present disclosure, the surface 508 comes into contact with and depresses the release mechanism 616, causing the gates 602 to open, releasing one of the one or more products 702. The one of the one or more products 702 falls onto the surface 508, and is surrounded by the product catch 506 on three sides, to keep the product securely on the surface 508 while the platform apparatus travels through the vending machine to dispense the one of the one or more products 702 to a user of the vending machine. Dispensing the product 702 can be performed by the platform apparatus 500 moving to the ejection position as shown in FIG. 5J to drop the product into an access port, such as access port 105.

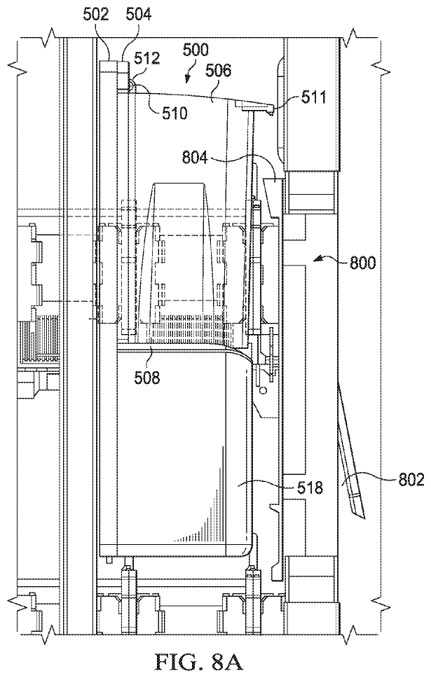

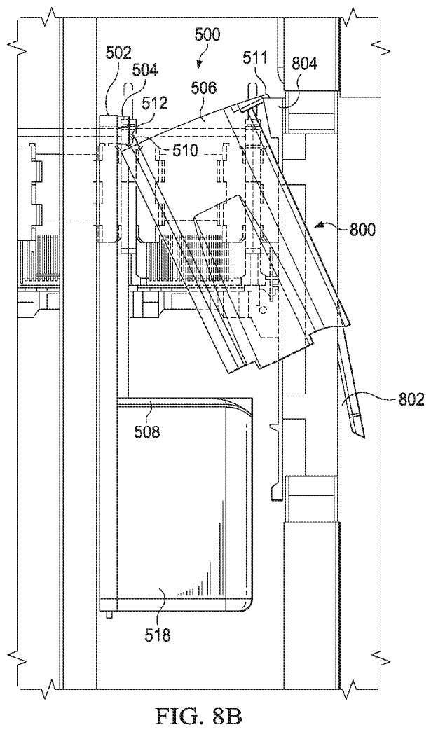

FIGS. 8A and 8B illustrate the platform apparatus 500 engaging a discharge frame 800 according to embodiments of the present disclosure. Discharge frames can come in a wide variety of configurations, and FIGS. 8A and 8B do not limit the scope of the present disclosure to any particular implementation of a discharge frame. The discharge frame 800 could be used with the vending machine 100 as shown in FIG. 1, or the vending machine 200 as shown in FIGS. 2A and 2B.

FIG. 8A illustrates a rear view of the platform apparatus 500 positioned above a discharge frame 800 according to embodiments of the present disclosure. FIG. 8B illustrates a rear view of the platform apparatus 500 engaging the discharge frame 800 according to embodiments of the present disclosure.

The discharge frame 800 is disposed at a location in a vending machine near an access port 802. The discharge frame 800 includes a discharge ledge 804 secured to a wall of the vending machine. As the platform apparatus 500 moves down towards the discharge frame 800, the ledge 511 of the product catch 506 comes into contact with the discharge ledge 804, causing the product catch 506 to rotate via the tabs 512 secured around the hinge 510. The rotation of the product catch 506 causes the product catch 506 to rotate up and away from the surface 508, where a product can be resting, into the product ejection position. The rotation thus causes the side of the product catch 506 that is near the plate 504 to come into contact with a product and push the product off the surface 508 and into the access port 802. The platform apparatus 500 can then move back up, causing the ledge 511 to cease contacting the discharge ledge 804. Once the ledge 511 ceases contact with the discharge ledge 804, the product catch 506 can then rotate back to the initial position.

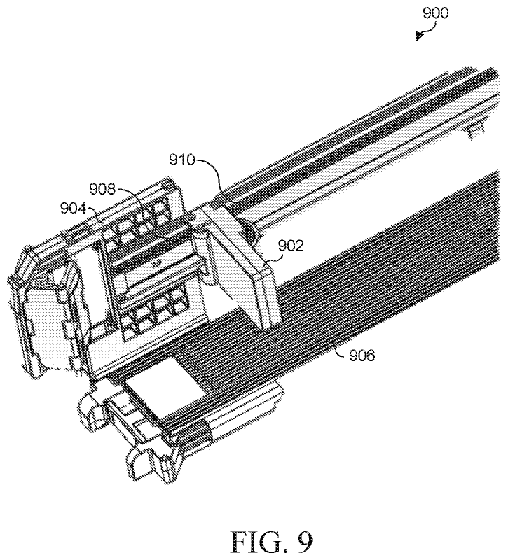

FIG. 9 illustrates a side mounted damper assembly 900 according to embodiments of the present disclosure. Damper assemblies can come in a wide variety of configurations, and FIG. 9 does not limit the scope of the present disclosure to any particular implementation of a damper assembly. The damper assembly 900 could be used with the vending machine 100 as shown in FIG. 1, or the vending machine 200 as shown in FIGS. 2A and 2B.

The damper assembly 900 includes a pusher plate 902 installed on a bracket or sidewall 904 of a product tray 906. The pusher plate 902 can have a spring installed thereon to provide a movement force to the pusher plate 902. The sidewall 904 can also include a recessed lane 908 having a rack geometry 910 that includes teeth oriented into the recessed lane 908. Sides of a gear damper within the pusher plate 902 can be disposed within the recessed lane 908 such that teeth of the gear damper face, and mesh with, the teeth of the rack geometry 910. The pusher plate 902 extends sideways from the sidewall 904 such that the pusher plate 902 is disposed above the product tray 906. As the pusher plate 902 travels along the sidewall 904, the pusher plate 902 contacts products on the product tray 906 to push the products towards a front of the product tray 906 for dispensing within a vending machine. The damper assembly 900 provides constant force via the spring to push products along the product tray 906. In some embodiments, the product tray 906 can be disposed at a particular angle, such as three degrees, while the force of the pusher plate 902 can be increased by using a rotary damper, to help alleviate tipping of products on the product tray 906.

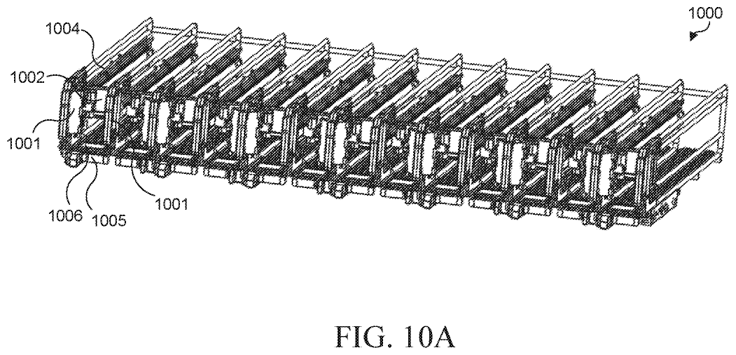

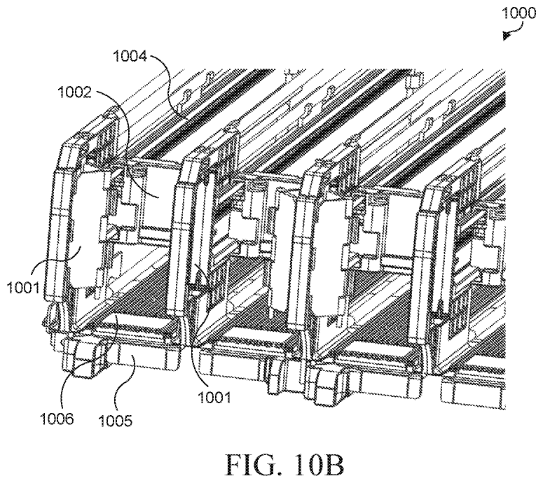

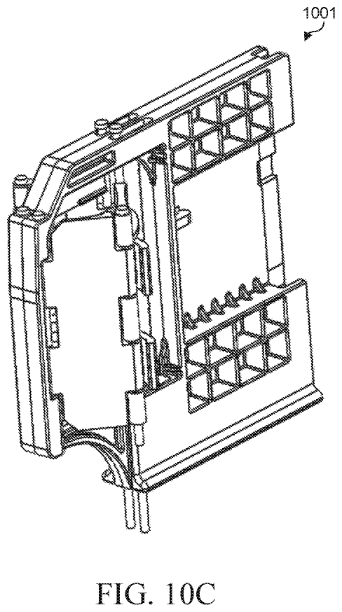

FIGS. 10A-10C illustrates various views of a shelf system 1000 according to embodiments of the present disclosure. FIG. 10A illustrates a front perspective view of the shelf system 1000 according to embodiments of the present disclosure. FIG. 10B illustrates an enlarged view of a portion of the shelf system 1000 according to embodiments of the present disclosure. FIG. 10C illustrates a side perspective view of a product gate 1001 of the shelf system 1000 according to embodiments of the present disclosure. Vending machine shelf systems can come in a wide variety of configurations, and FIGS. 10A-10C do not limit the scope of the present disclosure to any particular implementation of a shelf system. The shelf system 1000 could be used with the vending machine 100 as shown in FIG. 1, or the vending machine 200 as shown in FIGS. 2A and 2B.

The shelf system 1000 includes a plurality of product gates 1001 and pusher plates 1002 as described herein, such as with respect to FIGS. 6A-6D and FIG. 9. Sidewalls 1004 separate shelf rows or trays 1006 from each other, with each shelf row 1006 operable to maintain a plurality of products. Each shelf row 1006 has a button 1005 for opening the product gates 1001 when a product retrieval platform presses the button 1005. As described in the various embodiments herein, when a product retrieval platform presses one of the buttons 1005, the corresponding product gates open to allow a frontmost product to be deposited into the product retrieval platform. Using a gate 1001 at the front of the product row 1006 that both opens to allow a product to be dispensed, and closes to catch and maintain remaining products in the product row 1006 prevents issues in other vending machines that use both a product release gate and a product catching gate. For example, using both a release gate and a catching gate can result in products being caught and stuck in the catching gate, which can prevent or limit further vending of products.

In some embodiments, the product can slide by the force of gravity into the product retrieval platform when the product gates 1001 open. In some embodiments, the shelf system 1000 can be disposed at an angle matching the angle of the retrieval platform so that the products smoothly slide from the shelf system 1000 into the product retrieval platform. In some embodiments, the pusher plate 1002 can operate when the gates 1001 open to push the products down the product row 1006 towards the retrieval platform at a rate such that the frontmost product is deposited into the retrieval platform, and the gates 1001 close due to the retrieval platform releasing the button 1005 before a second product passes through the gates 1001. In some embodiments, the shelf system 1000 or the product can be disposed at a small angle, such as three degrees, while the force of the pusher plate 1002 can be increased by using a rotary damper that pushes the product into the retrieval platform, which helps alleviate tipping of products on the product tray 1006.

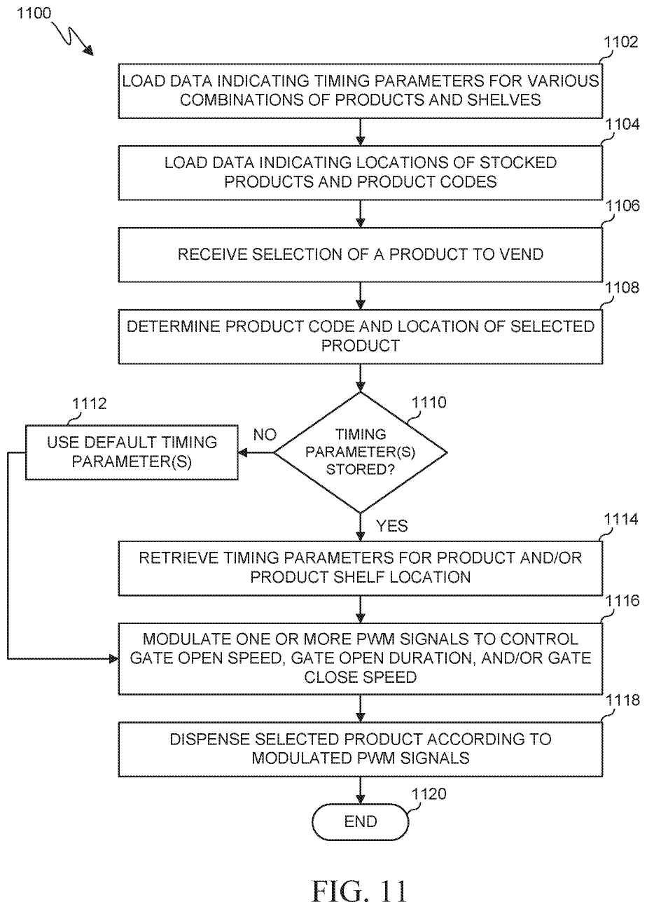

FIG. 11 illustrates a flowchart of a variable retrieval speed process 1100 according to embodiments of the present disclosure. FIG. 11 does not limit the scope of this disclosure to any particular embodiments. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. It will be understood that the process 1100 is described with respect to a processor of the vending machine 100, or the vending machine 200. However, the process 1100 can be used with any other suitable device(s) and in any suitable system.

At block 1102, the processor loads data indicating timing parameters for various combinations of products and shelves provided to the vending machine in memory. The timing parameters can include different timings for opening gates, duration that gates remain open, and closing gates. The timing parameters can be stored in association with certain products, certain vending machine shelf types, or both. For example, the timing parameters provided to the vending machine and stored in memory can be customized for a particular product or product type, such as defining how quickly to open a gate, how long to keep a gate open, and how quickly to close a gate, for the specific product. For instance, products can have different sizes and weights that can affect how quickly the products slide down a product row once a gate is opened. Heavier products that slide more quickly, for example, can have associated therewith timings for a smaller opening duration and a faster closing speed of the gate. In some cases, it may be that products slide quickly, but there is found to be a delay in which the product begins sliding. In such cases, the gate may be open for a longer duration to allow the products to begin sliding, but the gate closes quickly to prevent other fast sliding products from passing through the gate.

In a similar manner, gate timing can be controlled based on the type of product shelf or product rows, such as if a shelf or a product row includes certain dimensions, or if the shelf or product row is disposed at a particular angle within the vending machine. For example, if the shelf is disposed at a forty-five degree angle, products may slide down the product row faster than if the shelf is disposed at a three degree angle. Therefore, the timings for that shelf having that particular angle can be adjusted such that, for instance, the gate is open for a short duration and closes quickly to prevent subsequent products from also sliding through the gate. The timings can further be adjusted to account for both product type and shelf type. It will be understood that the above examples are merely for illustrating the types of gate timings that can be implemented, and do not limit this disclosure to any particular timings. A plurality of different timings can be used based on the products and the shelf or product row configuration.

At block 1104, the processor loads data indicating the locations of stocked products, and product codes associated with the stocked products. Thus, at block 1102, the timing parameters on various types of products and product locations can be stored ahead of time, but the timing parameters for these products and product locations are not necessarily specific to any currently stocked products. The timing parameters are stored such that they are available, and then, once the data indicating locations and product codes of stocked products is provided at block 1104, the timing parameters for those stocked products and their associated locations can be retrieved based on the previously stored timing parameters. In some embodiments, the timing parameters can be loaded at the same time as the data is loaded indicating the locations of stocked products and their product codes.

At block 1106, the processor receives a selection of a product to vend, such as column and row numbers, and/or letters, associated with locations in the vending machine. At block 1108, the processor determines a product code and location for the selected product based on the data loaded at block 1104 and based on the product selected at block 1106. In some embodiments, instead of receiving numeric or alpha-numeric indicators, the vending machine can include buttons or other user input components that each include an image or picture of a product, or otherwise identifies a product by name, flavor, or other identifier. Each of the buttons or other user input components is associated with a product stored in the memory of the vending machine in association with one or more product locations in the vending machine. Upon selection of a button or other user input component, at block 1108, the processor determines the product or product code associated with the button or other user input component, and determines a location for the selected product based on the selected product and based on the data loaded at block 1104. At decision block 1110, the processor determines whether timing parameters are stored for the selected product and/or the associated storage location of the product. If not, the process 1100 moves to block 1112, in which the processor retrieves default gate timing parameters to use. The process 1100 then moves to block 1116.

If, at decision block 1110, the processor determines that timing parameters are stored for the product and/or the product's location, the process 1100 moves to block 1114. At block 1114, the processor retrieves timing parameters for the product and/or the product location. At block 1116, the processor modulates one or more pulse width modulation (“PWM”) signals to control the timing of a product gate associated with the product and the product's location. In some embodiments, other control methods can be used, such as variable voltage or current methods. For example, the processor can modulate the PWM signals to control any or all of a gate open speed, a gate open duration, and a gate close speed. As described herein, altering gate open and close speeds, and gate open duration, allows for products of various types to be dispensed effectively and can account for various configurations of vending machine shelves. At block 1118, the processor, via the PWM signals to the product dispensers or gates, dispenses the selected product according to the modulated PWM signals and the timing parameters. The processor ends at block 1120.

Controlling of the speed and timing of product dispensing as described herein allows for the use of one product gate, such as shown in FIGS. 6A-6D. In other vending machines, when vending a product, the machine opens a front gate to allow exactly one product to move through the gate and dispense, while using a second rear gate that closes when the front gate opens to prevent other products from dispensing. The distance between the front and rear gates becomes a critical factor. Packages that do not fit this distance well cannot be vended reliably, limiting package flexibility.

The single gate design and adjustable timing disclosed herein allows for a greater range of package types. The timing parameters depend on numerous characteristics including the material, shape, weight, and contents of each product as well as the dimensions and other characteristics of the shelf holding the product. The transition speed between closed to open position of the gate, how long it should remain open, and how quickly the gate should transition from open to closed can all be controlled. In some embodiments, additional sensors can be installed within the vending machine that provide feedback on the timing parameters, which can be used to further optimize the timing parameters.

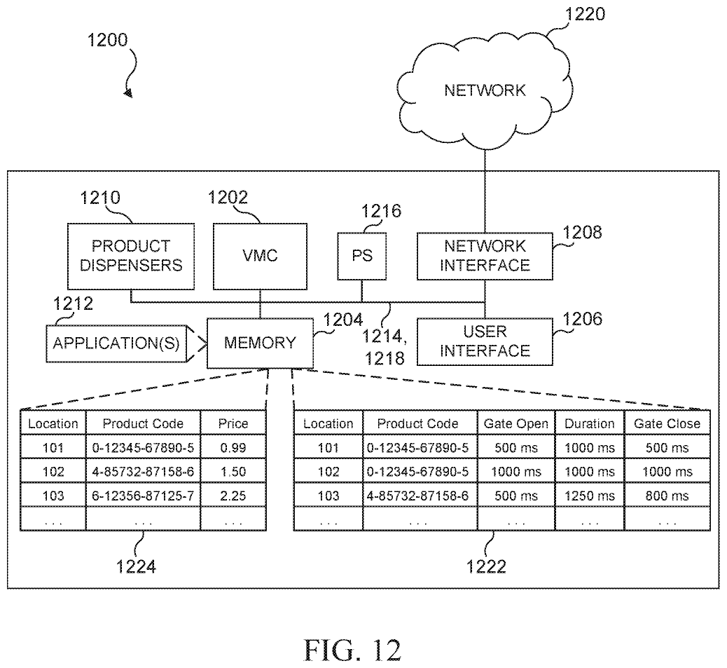

FIG. 12 illustrates an example vending machine variable timing system 1200 in accordance with various embodiments of this disclosure. The system 1200 can be one example of a portion or all of internal components of the vending machine 100 or 200 or other devices disclosed herein. The system 1200 includes at least one vending machine controller (“VMC”) (e.g., a processor/central processing unit (“CPU”)) 1202, at least one memory 1204, and a user interface 1206, and one or more product dispensers 1210, such as one of or a combination of the product retrieval platform, product release gates, or other dispensing components disclosed in the various embodiments herein. In some embodiments, the system 1200 can also include at least one network interface 1208, or network interface controllers (NICs). The network interface 1208 is configured to communicate with devices external to the vending machine system 1200 over a network 1220. In some embodiments, the system 1200 does not include a network interface. The components 1202, 1204, 1206, 1208, and 1210 can be interconnected by a data transport system (e.g., a bus) 1214. A power supply unit (PSU) 1216 provides power to components of the system 1200 via a power transport system 1218 (shown with data transport system 1214, although the power and data transport systems may be separate).

It will be understood that the system 1200 may be differently configured and that each of the listed components may actually represent several different components. For example, the VMC 1202 may actually represent a multi-processor or a distributed processing system; the memory 1204 may include different levels of cache memory, and main memory; the user interface 1206 may include monitors, keyboards, touchscreens, keypads, and the like, that can be used for products selection; the at least one network interface 1208 may include one or more network cards providing one or more wired and/or wireless connections to the network 1220. Therefore, a wide range of flexibility is anticipated in the configuration of the system 1200, which may range from a single physical platform configured primarily for a single user or autonomous operation to a distributed multi-user platform such as a cloud computing system. The network 1220 may be a single network or may represent multiple networks, including networks of different types, whether wireless or wired. For example, the system 1200 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the system 1200 with external devices.

The memory 1204, in various embodiments, can include instructions, utilized by the VMC 1202, for performing some or all of the steps, processes, and methods described herein. For example, the memory 1204 can store one or more applications 1212 that provide instructions for performing storing and retrieving timing parameters and currently stocked product data, and for adjusting the timing of the product dispensers 1210 based on the retrieved timing parameters and currently stocked product data. For example, the memory 1204 can store timing parameter data 1222, which, as illustrated in FIG. 12, can be based on criteria such as vending machine storage locations, represented, for example, by a location identifier, and product types, represented, for example, by product codes. In the various embodiments herein, the product code can be a universal product code (“UPC”).

The timing parameter data 1222 can further include product dispenser timings specific to combinations of vending machine storage locations and product types. For example, as illustrated in FIG. 12, a product having product code “0-12345-67890-5” stored at a location having identifier “101” can have a gate open speed of 500 ms, a gate open duration of 1000 ms, and a gate close speed of 500 ms. Since different locations in the vending machine may have different product shelf configurations, such as product shelf angle, the same product can have different timings for different locations. For example, the product having the same product code of “0-12345-67890-5” can be associated with different timings if stored at a different location, such as shown in FIG. 12 when stored at another location with location identifier “102.” When this same product type is stored at this other location, the timings are altered to have a gate open speed, a gate open duration, and a gate close speed of 1000 ms.

The timing parameter data 1222, in some embodiments, can be pre-loaded before data concerning stocked products and associated locations is loaded. As such, data on a specific product and location can be stored ahead of time in the event that such a product and location combination are used in the vending machine. As such, it will be understood that the timing parameter data 1222 can include any number of timings for products, vending machine storage locations, or combinations thereof, and the examples shown in FIG. 12 are not limiting. The memory 1204 also can store stocked product data 1224. The stocked product data 1224 includes products, such as identified by product codes, the locations in the vending machine where the products are currently stored, prices for the products, and other information. When a customer selects a product for vending via the user interface 1206, the VMC 1202 retrieves the price and product code for the location from the stocked product data 1224 in the memory 1204. The VMC 1202 can use the location and product code to also retrieve product dispenser timings from the timing parameter data 1222 in the memory 1204 for the product and location combination. The VMC 1202 can then, as disclosed in the various embodiments herein, adjust the timings of the product dispenser for the specific product, location, or combination thereof.

The various embodiments described herein can also be used in a micromarket environment. In a micromarket, customers can walk in, open a door and pick up a product. They can pay after taking products from a shelf. Some cashless stores employ multiple sensors to observe products on shelves and use data from those shelves to determine if a product is picked up. In some cases, products are behind a gate. If a product is behind a gate that permits variable times in closing, variable gate closing times as described in the various embodiments herein could reduce or eliminate using a sensor to monitor if a product is picked, especially if shelves are at an angle and when a customer is pulling out a product the gate opens to allow customer to pull the product and closes afterwards, ensuring that only one product is pulled at a time. In one aspect thereof, a vending machine comprises a chassis, at least one shelf including a plurality of product rows, a plurality of product gates each coupled to an associated one of the plurality of product rows, a movable stage, a retrieval platform coupled to the movable stage, wherein the retrieval platform is operable to move to accept a product from one of the plurality of product rows, and a vending machine controller coupled to at least one memory. The vending machine controller is configured to determine a product code and a storage location of a selected product for vending, retrieve, from the at least one memory, timing parameters associated with at least one of the product code or the storage location of the selected product, and control one or more timings of one of the plurality of product gates associated with the determined storage location of the selected product, based on the retrieved timing parameters, to release the selected product from the at least one shelf to the retrieval platform.

In some vending machine systems, when receiving a product from a column or a product tray into a non-tilting platform or dispenser having a horizontal base, the product may tilt or bridge. Bridging occurs when the top of a product tilts during the vending process and is unable to move from the tray into the dispenser. Tilting and bridging lead to failed product exchanges from the tray to the dispenser. Additionally, products on a product tray can slide into the product retrieval platform from the product tray when a product gate is opened. The product gate then closes to retain other products on the product tray. However, different product types can slide or move down the product tray at different rates depending on various aspects of the product such as the size or weight of the product. If the product gates were to all open and close at the same rates, this could lead to failed product exchanges in which a product is not released from the tray or is caught in the gate due to the gate closing too soon, for example. In some cases, it may be that products slide quickly, but there is found to be a delay in which the product begins sliding. In addition, different product trays, such as product trays of different angles, can cause products to slide at different rates.

To address the technical problems above, this disclosure provides a vending machine comprising a chassis, at least one shelf system including a plurality of product rows, a plurality of product gates each coupled to an associated one of the plurality of product rows, a movable stage, a retrieval platform coupled to the movable stage, wherein the retrieval platform is operable to move to accept a product from one of the plurality of product rows, and a vending machine controller coupled to at least one memory. The vending machine controller is configured to determine a product code and a storage location of a selected product for vending, retrieve, from the at least one memory, timing parameters associated with at least one of the product code or the storage location of the selected product, and control one or more timings of one of the plurality of product gates associated with the determined storage location of the selected product, based on the retrieved timing parameters, to release the selected product from the at least one shelf system to the retrieval platform.

To address the technical problems above, this disclosure also provides a method of dispensing a product from a vending machine comprising receiving data on a selected product for vending, determining a product code and a storage location of a selected product for vending, retrieving timing parameters associated with at least one of the product code or the storage location of the selected product, moving a retrieval platform coupled to a moveable stage to a position to accept the selected product from one of a plurality of product rows of at least one shelf system of the vending machine, and controlling one or more timings of one of a plurality of product gates associated with the determined storage location of the selected product, based on the retrieved timing parameters, to release the selected product from the at least one shelf system to the retrieval platform, wherein each of the plurality of product gates are coupled to an associated one of the plurality of product rows.

Manufacturing variations in vending machines can create differences in product location with reference to a “home” position from machine to machine, and variations in the interface with the delivery location with reference to a “home” position. Additionally, because of variations in the terrain where a machine is placed and how it is leveled, and other factors such has insulating foam swelling, the delivery location interface can change with reference to a “home” position within an individual machine from the factory to the placement location, and even over time in a single machine at a single placement location. These variations can cause a product delivery mechanism in the vending machine to incorrectly dispense products, such as either failing to move to the correct location to retrieve a product from a shelf, or fail to move to the correct position to dispense the product to a delivery location for customer retrieval.

In current systems, the storage shelf locations are selected by a factory operator from a menu of preset selections before a machine is shipped. This assumes that the shelf location is fixed and is not configurable by the machine owner to accommodate different sized products over the life of the machine. Compensation for the manufacturing variation in the location of the shelves with respect to a “home” position is programmed into the vending machine controller by a factory operator. This is prone to human error and requires time in the manufacturing process. Compensation for variations in the location of the shelves with respect to the “home” position of a product delivery mechanism, such as the product cup or platform 220, can be referred to as “vertical calibration.” Vertical calibration involves programming a shelf offset, which defines the variation of the home position of the product delivery mechanism and the bottom of the shelf and the location of a product release mechanism, such as the button 616.

For example, as shown in FIGS. 13A and 13B, a correct vertical calibration or correct shelf offset results in a product delivery mechanism being aligned with a product release mechanism 1304. In some embodiments, the product delivery mechanism can be the surface 508 shown in FIGS. 6B and 7A, or a moveable release arm 1302 as shown in FIGS. 13A and 13B, such that the product delivery mechanism can move to contact the product release mechanism 1304, which can be the button 616 in some embodiments.

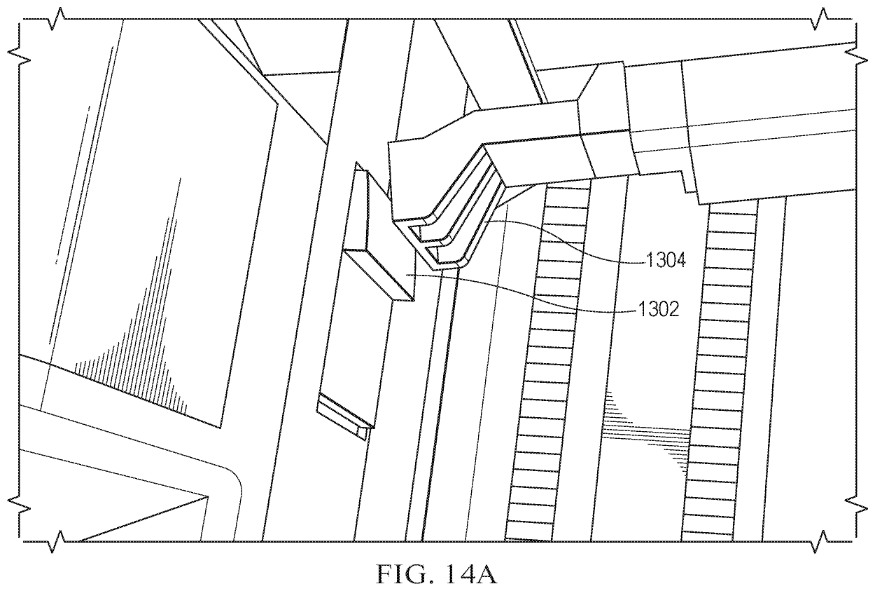

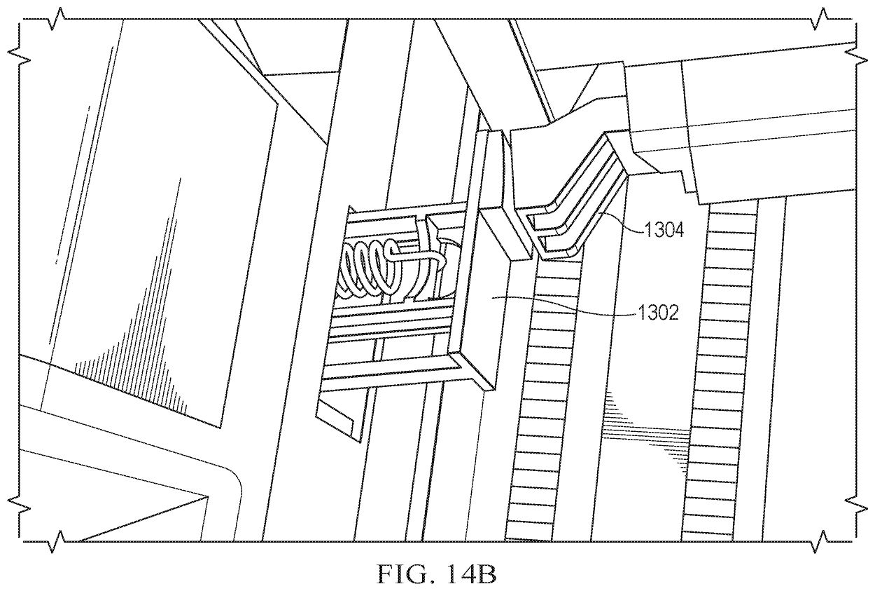

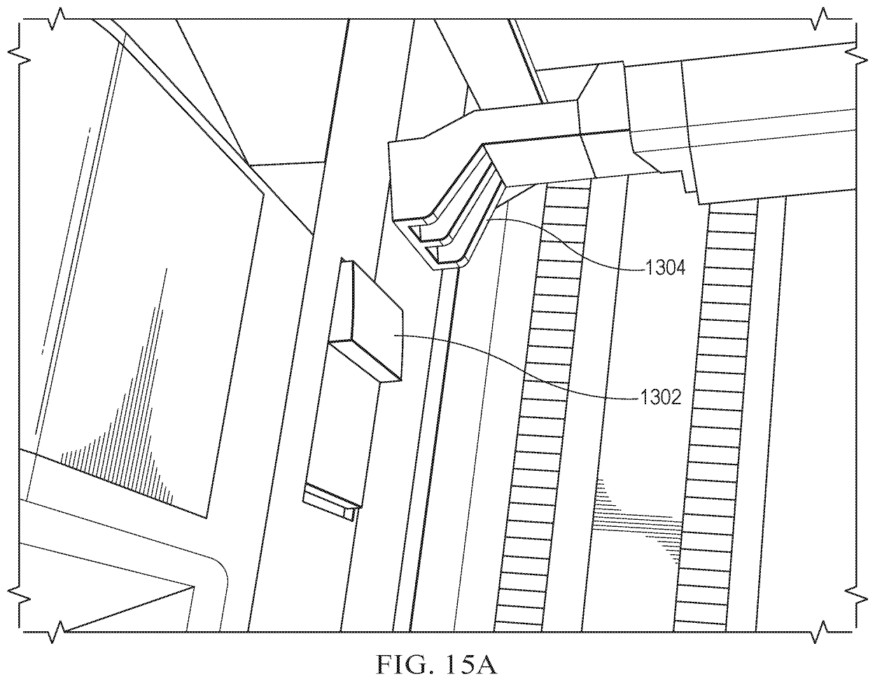

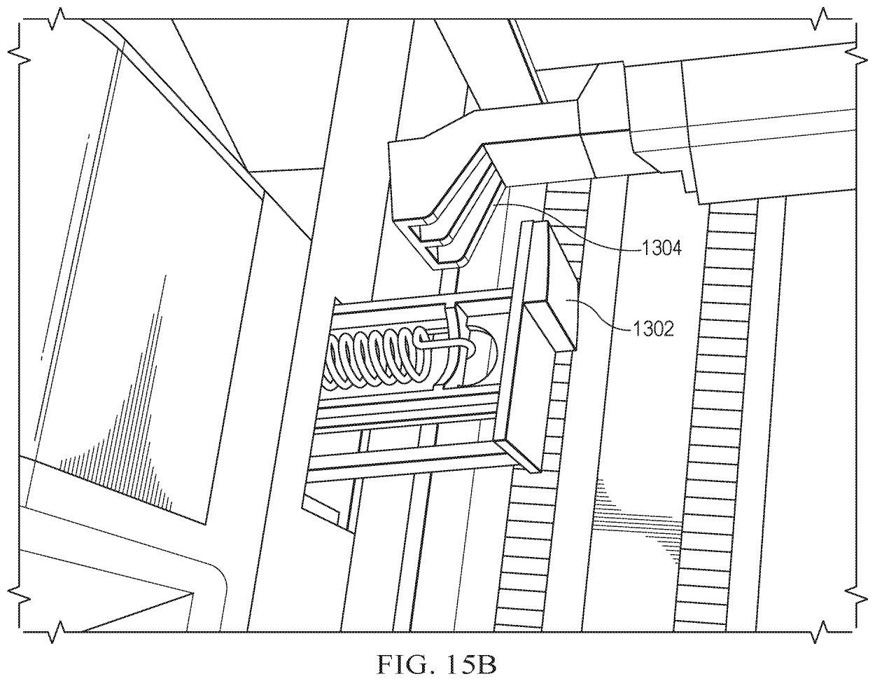

When the shelf offset is incorrect, the product delivery mechanism can become misaligned such that the product delivery mechanism either contacts the product release mechanism 1304 of the shelf at an angle, or completely misses the product release mechanism, as shown in FIGS. 14A and 14B in which the product delivery mechanism is too high, or FIGS. 15A and 15B in which the product delivery mechanism is too low.

Additionally, compensation for the manufacturing variation in the location of the delivery interface can be either programmed into the vending machine by a factory operator, which is prone to human error and takes time in the manufacturing process, or automatically detected by the vending machine controller using a model that detects the interface by means of stalling a motor that controls the delivery device against the delivery interface. This is prone to other errors and variation in manufacturing that would create a motor stall prior to finding the product delivery interface. Compensation for variations in the location of the delivery interface, such as the access port 105, with respect to the “home” position of a product delivery mechanism, such as the product cup or platform 220, can be referred to as “horizontal calibration.” Horizontal calibration involves programming a hook offset, that is, how far the product delivery mechanism has to travel to the access port to dispense a product.

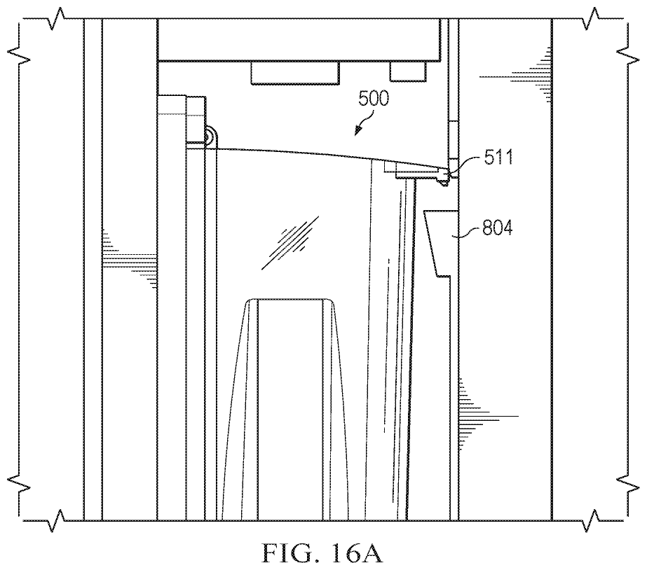

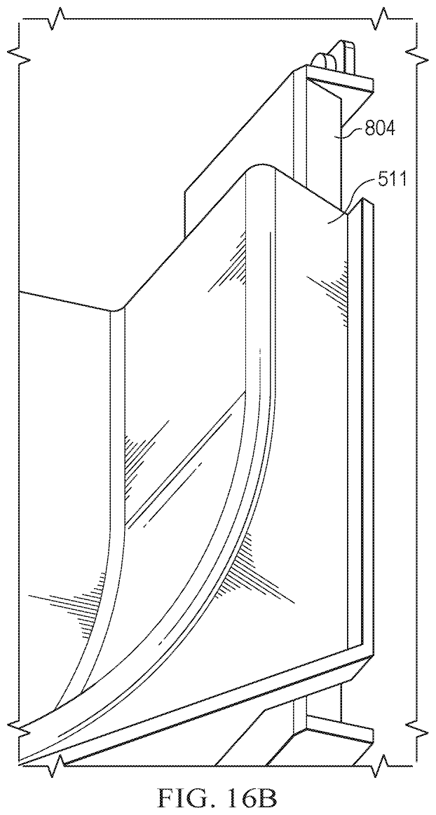

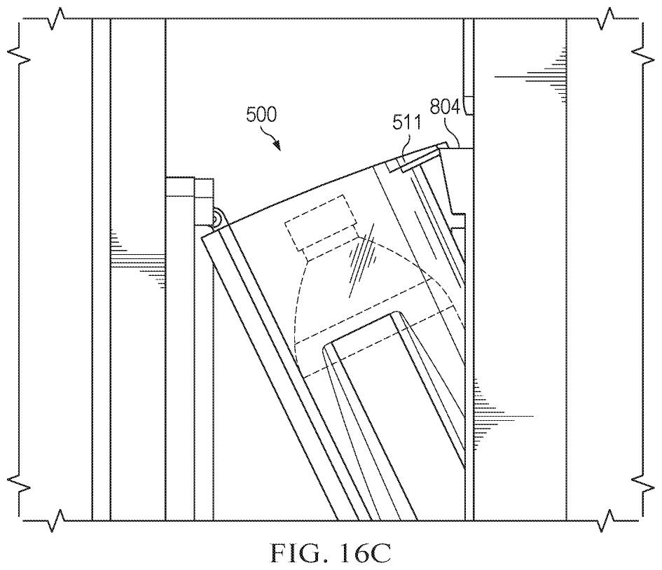

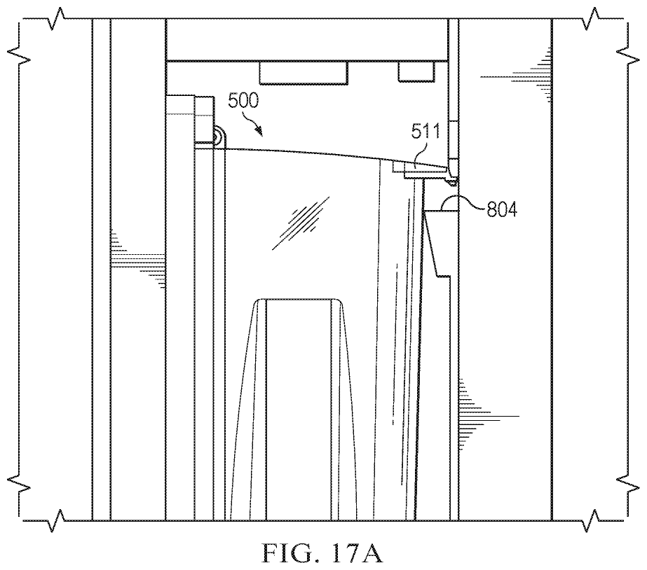

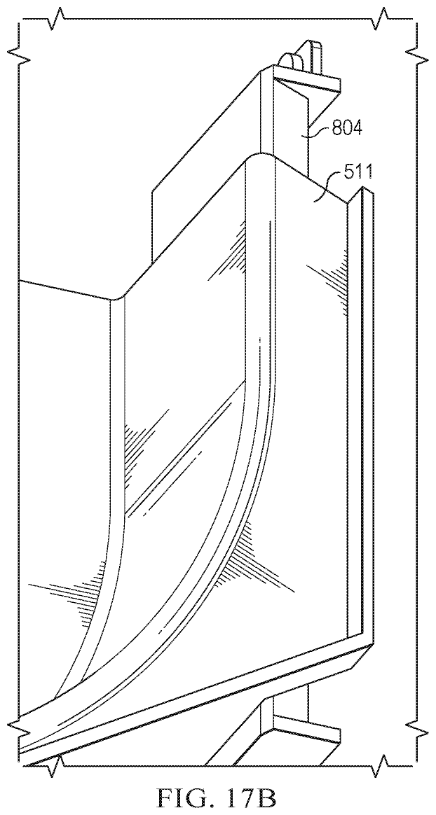

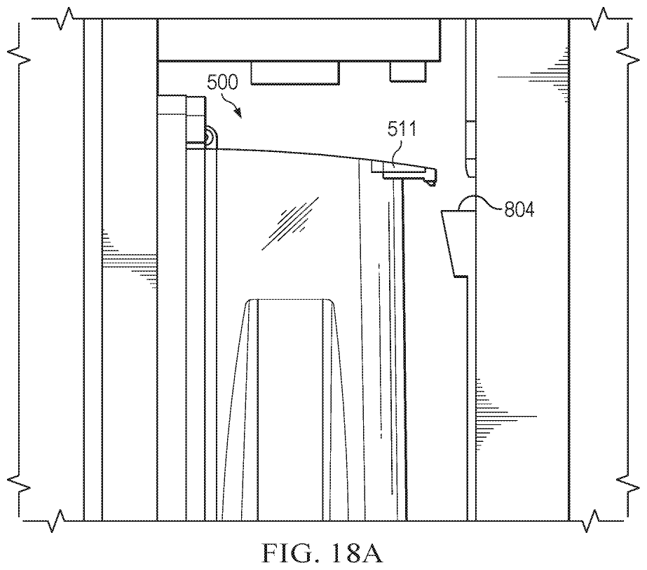

For example, a hook or ledge of the product delivery mechanism, such as the ledge 511 of the product cup or platform 500 illustrated in FIG. 8A, when correctly positioned due to a correct horizontal calibration, can contact a discharge ledge, such as discharge ledge 804, and as also shown in FIGS. 16A-16C, causing the product delivery mechanism to move or tilt and deposit a carried product into the access port for customer retrieval. If the horizontal offset is not correctly calibrated, the hook of the product delivery mechanism can move too far, and can contact the wall of the vending machine, such as shown in FIGS. 17A and 17B, or not far enough, such as shown in FIGS. 18A and 18B, such that the hook cannot contact the discharge ledge.

Compensation for the variation in the location of the delivery interface that is introduced by the environment and leveling of a machine once it is placed on location, and the variation that can happen over time with the insulating foam swelling or shrinking, cannot be accounted for at the factory and must be dynamically detected, with the vending machine stalling the delivery system against the delivery interface at intervals over the life of the machine. This is also prone to the same errors identified above. The location of each product is programmed into the vending machine controller by the machine owner or his agent such as a service technician or a product delivery person. This also is prone to human error by either forgetting to program product location, forgetting to change the program when locations change, or accidentally loading a product into the wrong location. It also requires time from the machine owner or his agent to properly program each product location and to keep up with changes. Additionally, the price of each product is programmed into the vending machine controller by the machine owner or his agent, which is prone to the same errors and time requirements as detailed above. There is therefore a need for a system to reduce or eliminate human error and the time required to resolve the above problems.

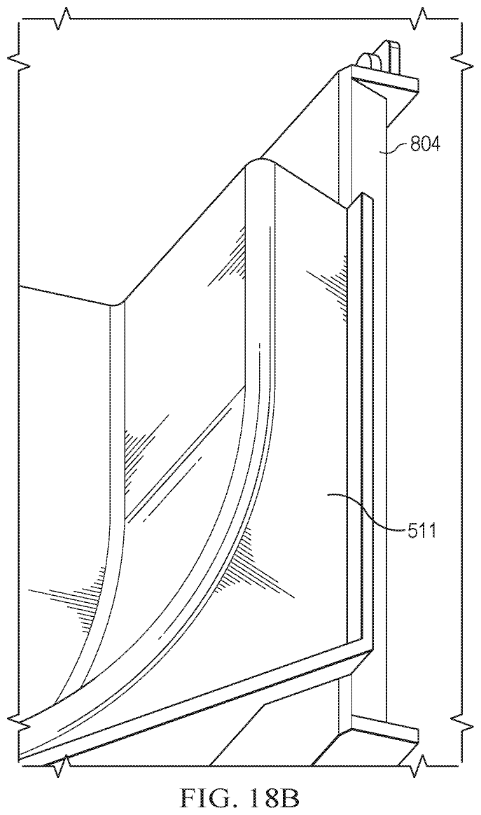

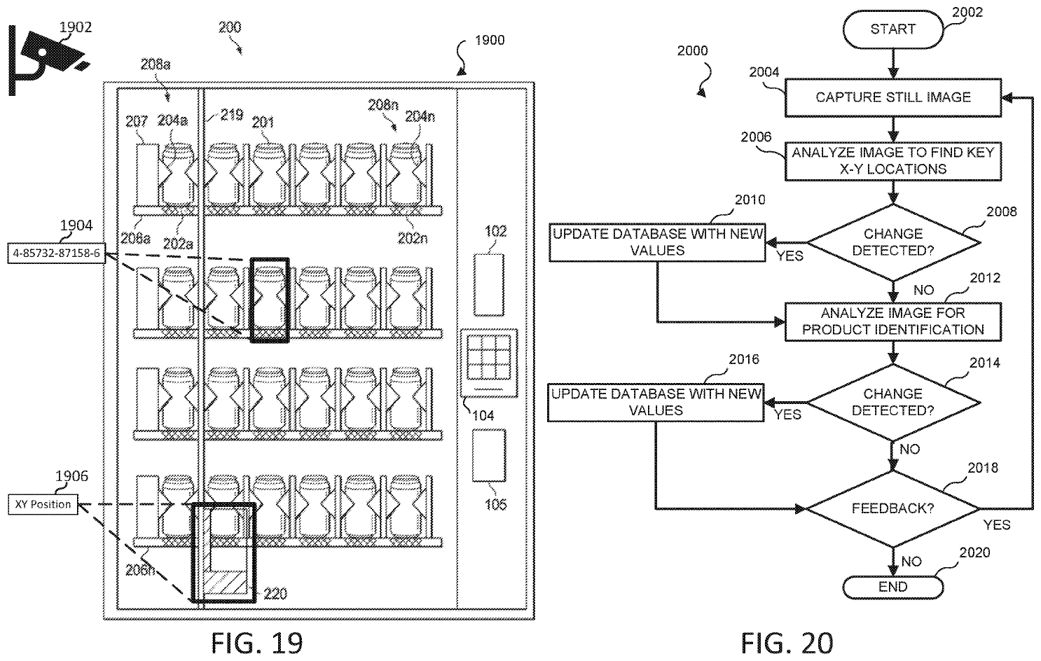

FIG. 19 illustrates a vending machine monitoring and image capture system 1900 in accordance with various embodiments of this disclosure. The system 1900 includes a vending machine, such as the vending machine 200, and at least one image capture device 1902, which can be a still image or video camera device. In some embodiments, the image capture device 1902 is mounted or otherwise placed in a location in proximity to the vending machine such that the image capture device 1902 can capture images of the vending machine, particularly the internal compartment housing the product shelves, products, and delivery mechanisms. In some embodiments, one or more image capture devices 1902 can be placed within the internal compartment of the vending machine to capture images of the interior of the vending machine. In some embodiments, the camera can be mounted on an X-Y platform. In some embodiments, one or more image capture devices 1902 can be installed on an exterior portion of the chassis of the vending machine, and positioned to view through a front window of the vending machine into the internal compartment to capture images of the interior of the vending machine. In some embodiments, during service or restocking of the vending machine, an operator can use an image capture device 1902, such as a handheld camera and/or a smartphone device, to capture images of the internal compartment of the vending machine.

In order to reduce or eliminate the human error and the time required to resolve problems with shelf and hook offsets and problems with the updating of product information in the system, a static image of the machine storage area, captured using the image capture device 1902, can be used, with image processing models, to determine what product is stored in each location, the shelf location with reference to the “home” position, and the location of the delivery interface with reference to the “home” position in an x-y coordinate system. The image processing model can be programmed, and/or trained, to recognize the machine's physical features to identify the product locations, shelf locations, and delivery interface and determine their position in an x-y coordinate system relative to a “home” location. In some embodiments, to aid the image processing model to recognize these locations, a visual marker that can be recognized by the image processing model can be placed in fixed proximity to these key features. The visual marker can be a geometric pattern or other visual marker. The image of the vending machine can be analyzed by the image capture device 1902, or transmitted over a network, such as network 1220 of FIG. 12, to a server for analysis by either the image capture device 1902, or the vending machine using the network interface 1208, if the vending machine is communicatively connected to the image capture device, such as via a wired connection, or wireless connection such as a BLUETOOTH connection.

For example, as shown in FIG. 19, an image of the vending machine is used to visually identify a product disposed on one of the shelves that is associated with a product code 1904. If the identified product is not the same product currently stored in the vending machine memory, such as shown in FIG. 12, for that shelf position in the vending machine, the memory of the vending machine is updated via an instruction from the vending machine or transmitted to the vending machine from the server or image capture device 1902, which in turn also updates other product information stored in memory such as product price and gate open and close timings, for example as described in this disclosure with respect to FIGS. 11 and 12.

The image of the vending machine can also be used to determine the location of the product delivery mechanism, such as an X-Y position 1906 of the product delivery mechanism 220. The image can be taken while the product delivery mechanism is at various positions, such as at the starting position, e.g., situated in a bottom corner of the vending machine opposite the access port 105, or at other positions such as in a product retrieval position in front of a product shelf, or in a product dispensing position in proximity to the access port. From the X-Y position detected in the image by either the vending machine, image capture device 1902, or the server, the current shelf offset and/or hook offset is determined, and, if the offset indicates the product retrieval mechanism needs vertical and/or horizontal calibration to better align the product retrieval mechanism with either the shelves or the access port, the vending machine, image capture device 1902, or the server provides an instruction to update the position of the product retrieval mechanism with respect to the “home” position.

By using the static image to resolve the location of the product storage shelves, the product delivery interface, and the type of product at each location, the time for an operator to program these parameters, as well as the human error, is eliminated. Using a static image each time the vending machine is loaded with new product will eliminate the problem of making sure product location is reprogrammed and also will provide a convenient time interval for catching variations in the product delivery location interface.

The image processing model(s) disclosed herein can be a machine learning model that is trained to recognize objects such as products or the product delivery mechanism within the vending machine. Such machine learning models can include convolutional neural networks (CNNs), such as a deep and/or a region based CNNs, single shot detector (SSD) models, You Only Look Once (YOLO) models, or other image recognition models. For example, in some embodiments, the image processing model(s) is trained to detect a product in a captured image based on recognition of the product packaging, create a bounding pox around the product such as shown in FIG. 19, and, using an associated product database, retrieve and/or store information about the product such as the product code 1904. Additionally or alternatively, in some embodiments, the image processing model(s) is trained to detect the X-Y position 1906 of the product delivery mechanism by detecting the product delivery mechanism in a captured image based on trained object recognition parameters matching the shape of the product delivery mechanism. In some embodiments, the image processing model(s) can create a bounding box in the image around the product delivery mechanism, such as shown in FIG. 19. Based on the orientation and position of the image capture device 1902 as well as the location of the product delivery mechanism within the image, the image processing model(s) and/or a processor located locally to the vending machine or remotely, such as at a remote server, can determine the X-Y position of the product delivery mechanism, and determine if the product delivery mechanism is offset from the intended “home” position, and, if so, the product delivery mechanism can be recalibrated as described in the various embodiments of this disclosure.

FIG. 20 illustrates a product identification and product delivery mechanism calibration process 2000 in accordance with various embodiments of this disclosure. It will be understood that the process 2000 can be executed by a processor of one or more of an image capture device, a vending machine, or one or more servers, such as described with respect to FIG. 19.

The process 2000 starts at block 2002, and, at block 2004, an image of a vending machine is captured, such as by the image capture device 1902. At block 2006, the processor analyzes the image, such as a processor of one of the image capture device, the vending machine, or the server as described with respect to FIG. 19, to determine key X-Y locations relative to positions within the vending machine and with respect to the locations of a product delivery mechanism, shelves in the vending machine, and an access port.

At decision block 2008, the processor determines if a change is detected. For example, the processor can determine whether the product delivery mechanism is positioned with correct shelf or hook offsets and relative to the “home” position, as well as X-Y coordinates of other objects in the image such as the shelves or access port, or if the position of the product delivery mechanism has changed relative to these objects within the vending machine. If so, the process 2000 moves to block 2010, in which the processor updates a database and/or the memory 1204 with new values or parameters. For example, the processor may update the vertical and/or horizontal offset of the product delivery mechanism relative to a “home” position, to correct one or more of the shelf or hook offset. The process 2000 then moves to block 2012. If, at decision block 2008, the processor does not detect a change, or otherwise does not determine corrective action is needed with respect to the determined X-Y coordinates, the process 2000 moves to block 2012.

At block 2012, the processor analyzes the captured image to identify products in the image and stored on shelves of the vending machine. At decision block 2014, the processor determines if a change is detected. For example, the processor can determine whether a product stored at a location on a shelf within the vending machine is the product that is expected to be there as compared to product information and product location information in a database or in the memory 1204, or if a different product is present at the X-Y location. If a different product than expected is present at the location, the process 2000 moves to block 2016, in which the processor updates a database and/or the memory 1204 with new values or parameters. For example, the processor may update the database or memory with the detected product's product ID and other information related to the product such as the product price or gate open and close timings. The process 2000 then moves to decision block 2018. If, at decision block 2014, the processor does not detect a change, or otherwise does not determine corrective action is needed with respect to the products identified in the image, the process 2000 moves to decision block 2018.

At decision block 2018, the processor determines if feedback is received. For example, if the image captured in block 2004 does not meet a quality threshold, is taken at an angle that inhibits object detection, etc., the device in receipt of the image, such as the server, can provide a feedback loop in which an instruction is provided to attempt image re-capture, and the process 2000 moves back to block 2004. This feedback loop can continue, with the process 2000 looping from decision block 2018 back to block 2004, until no feedback, or positive feedback, is provided, at which point, the process 2000 ends at block 2020.

Although FIG. 20 illustrates one example of a product identification and product delivery mechanism calibration process 2000, various changes may be made to FIG. 20. For example, while shown as a series of steps, various steps in FIG. 20 could overlap, occur in parallel, occur in a different order, or occur any number of times.

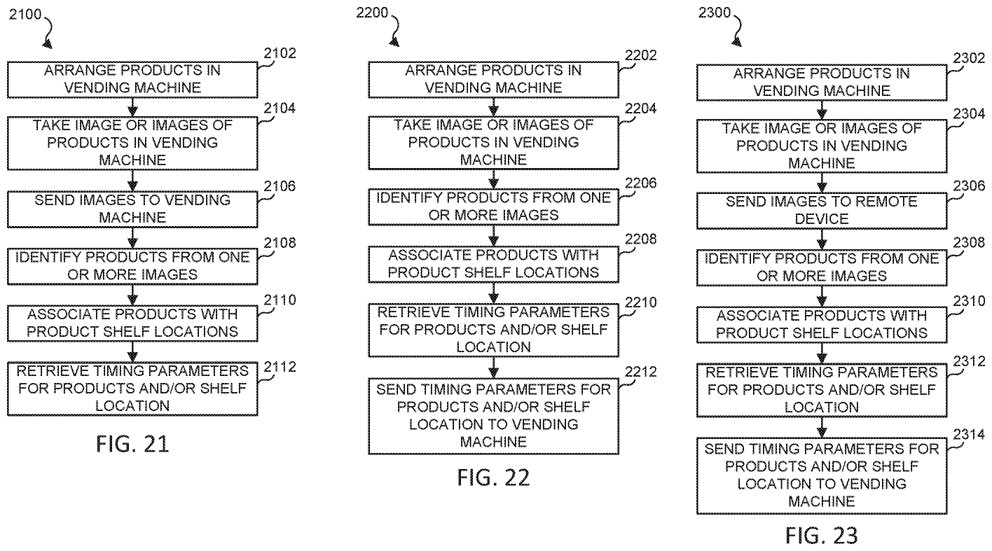

FIG. 21 illustrates an example product identification and gate timing parameters process 2100 in accordance with various embodiments of this disclosure. It will be understood that at least portions of the process 2100 can be executed by a processor of one or more of an image capture device, a vending machine, or one or more servers, such as described with respect to FIG. 19. In this example, an operator captures images of the vending machine and products within the vending machine using a handheld device, such as a smartphone, and the images are provided to the vending machine for processing, such as via a wired or wireless network connection and via a server, via BLUETOOTH, or another wireless connection, or another wired connection such as a USB connection.

At step 2102, products are arranged in the vending machine. At step 2104, the operator captures one or more images of products in the vending machine using the handheld device. At step 2106, images are sent from the handheld device to the vending machine. At step 2108, the vending machine identifies products from the images, such as described with respect to FIGS. 19 and 20. At step 2110, the vending machine associates products with shelf locations. At step 2112, the vending machine retrieves timing parameters for products and/or product shelf locations, such as timing parameters stored locally or on a remote server. The timing parameters for products and/or product shelf locations can be used to adjust parameters such as gate timing parameters, as described in various embodiments of this disclosure.

Although FIG. 21 illustrates one example of a product identification and gate timing parameters process 2100, various changes may be made to FIG. 21. For example, while shown as a series of steps, various steps in FIG. 21 could overlap, occur in parallel, occur in a different order, or occur any number of times.

FIG. 22 illustrates another example product identification and gate timing parameters process 2200 in accordance with various embodiments of this disclosure. It will be understood that at least portions of the process 2200 can be executed by a processor of one or more of an image capture device, a vending machine, or one or more servers, such as described with respect to FIG. 19. In this example, an operator captures images of the vending machine and products within the vending machine using a handheld device, such as a smartphone, and the handheld device performs processing on the images and sends results to the vending machine such as via a wired or wireless network connection via a server, via BLUETOOTH, or another wireless connection, or a wired connection such as a USB connection.

At step 2202, products are arranged in the vending machine. At step 2204, the operator captures one or more images of products in the vending machine using the handheld device. At step 2206, the handheld device identifies products from the images, such as described with respect to FIGS. 19 and 20. At step 2208, the handheld device associates products with shelf locations in the vending machine. At step 2210, the handheld device retrieves timing parameters for products and/or product shelf locations, such as timing parameters stored locally or on a remote server. At step 2212, the handheld device sends the timing parameters for products and/or product shelf locations to the vending machine. The timing parameters for products and/or product shelf locations can be used to adjust parameters such as gate timing parameters, as described in various embodiments of this disclosure.

Although FIG. 22 illustrates one example of a product identification and gate timing parameters process 2200, various changes may be made to FIG. 22. For example, while shown as a series of steps, various steps in FIG. 22 could overlap, occur in parallel, occur in a different order, or occur any number of times.

FIG. 23 illustrates another example product identification and gate timing parameters process 2300 in accordance with various embodiments of this disclosure. It will be understood that at least portions of the process 2300 can be executed by a processor of one or more of an image capture device, a vending machine, or one or more servers, such as described with respect to FIG. 19. In this example, an operator captures images of the vending machine and products within the vending machine using a handheld device, such as a smartphone, and the images are provided to a remote computer or server for processing, such as via a wired or wireless network connection, via BLUETOOTH, or another wireless connection, or a wired connection such as a USB connection.

At step 2302, products are arranged in the vending machine. At step 2304, the operator captures one or more images of products in the vending machine using the handheld device. At step 2306, images are sent from the handheld device to the remote computer. At step 2308, the remote computer identifies products from the images, such as described with respect to FIGS. 19 and 20. At step 2310, the remote computer associates products with shelf locations. At step 2312, the remote computer retrieves timing parameters for products and/or product shelf locations, such as timing parameters stored locally or on another remote server. At step 2314, the remote computer sends the timing parameters for products and/or product shelf locations to the vending machine, such as via a wired or wireless network connection. The timing parameters for products and/or product shelf locations can be used to adjust parameters such as gate timing parameters, as described in various embodiments of this disclosure.

Although FIG. 23 illustrates one example of a product identification and gate timing parameters process 2300, various changes may be made to FIG. 23. For example, while shown as a series of steps, various steps in FIG. 23 could overlap, occur in parallel, occur in a different order, or occur any number of times.

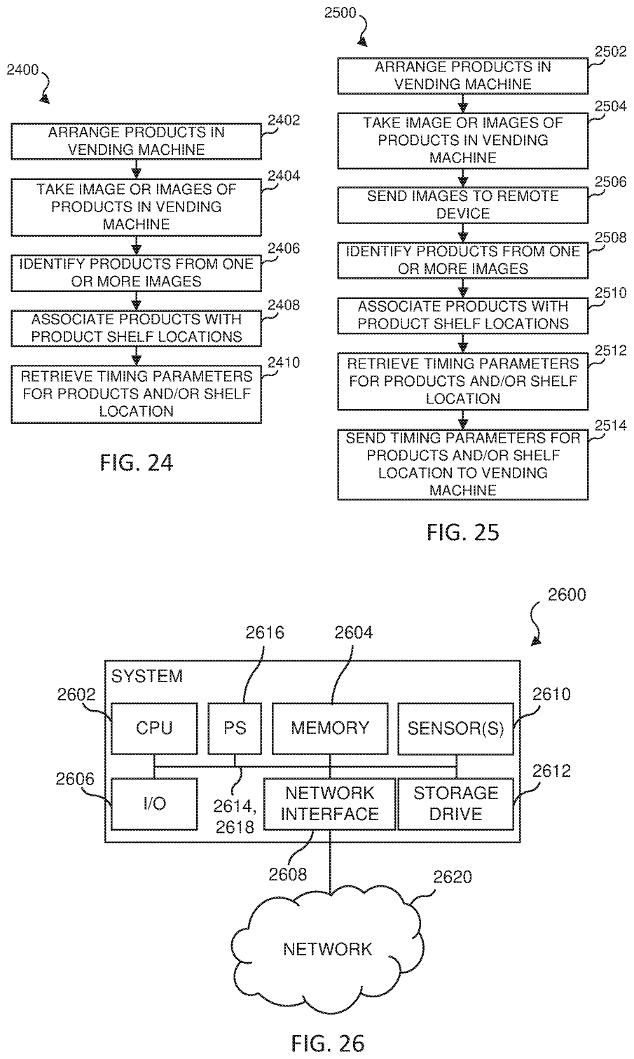

FIG. 24 illustrates another example product identification and gate timing parameters process 2400 in accordance with various embodiments of this disclosure. It will be understood that at least portions of the process 2400 can be executed by a processor of one or more of an image capture device, a vending machine, or one or more servers, such as described with respect to FIG. 19. In this example, a camera mounted near, inside, or on the X-Y platform in the vending machine captures images of the vending machine and products within the vending machine, and the images are provided to the vending machine for processing, such as via a wired or wireless network connection.

At step 2402, products are arranged in the vending machine. At step 2404, the mounted camera captures one or more images of products in the vending machine. At step 2406, the mounted camera provides the images to the vending machine and the vending machine identifies products from the images, such as described with respect to FIGS. 19 and 20. At step 2408, the vending machine associates products with shelf locations. At step 2410, the vending machine retrieves timing parameters for products and/or product shelf locations, such as timing parameters stored locally or on a remote server. The timing parameters for products and/or product shelf locations can be used to adjust parameters such as gate timing parameters, as described in various embodiments of this disclosure.

Although FIG. 24 illustrates one example of a product identification and gate timing parameters process 2400, various changes may be made to FIG. 24. For example, while shown as a series of steps, various steps in FIG. 24 could overlap, occur in parallel, occur in a different order, or occur any number of times.

FIG. 25 illustrates another example product identification and gate timing parameters process 2500 in accordance with various embodiments of this disclosure. It will be understood that at least portions of the process 2500 can be executed by a processor of one or more of an image capture device, a vending machine, or one or more servers, such as described with respect to FIG. 19. In this example, a camera mounted near, inside, or on the X-Y platform in the vending machine captures images of the vending machine and products within the vending machine, and the images are provided to a remote computer or server for processing, such as via a wired or wireless network connection.

At step 2502, products are arranged in the vending machine. At step 2504, the mounted camera captures one or more images of products in the vending machine. At step 2506, images are sent from the mounted camera to the remote computer. At step 2508, the remote computer identifies products from the images, such as described with respect to FIGS. 19 and 20. At step 2510, the remote computer associates products with shelf locations. At step 2512, the remote computer retrieves timing parameters for products and/or product shelf locations, such as timing parameters stored locally or on another remote server . . . . At step 2514, the remote computer sends the timing parameters for products and/or product shelf locations to the vending machine, such as via a wired or wireless network connection. The timing parameters for products and/or product shelf locations can be used to adjust parameters such as gate timing parameters, as described in various embodiments of this disclosure.

Although FIG. 25 illustrates one example of a product identification and gate timing parameters process 2500, various changes may be made to FIG. 25. For example, while shown as a series of steps, various steps in FIG. 25 could overlap, occur in parallel, occur in a different order, or occur any number of times.

FIG. 26 illustrates an example electronic device 2600 in accordance with various embodiments of this disclosure. The device 2600 can be one example of a vending machine 200, an image capture device 1902, a handheld device, a remote computer or server, or any other electronic device described in this disclosure. The system 2600 can include a controller (e.g., a processor/central processing unit (“CPU”)) 2602, a memory unit 2604, and an input/output (“I/O”) device 2606. The device 2600 also includes at least one network interface 2608, or network interface controllers (NICs). The device 2600 further includes at least one capture device 2610 for capturing media or inputs to the system through an I/O device. In some embodiments, the capture device is not included. The device 2600 also includes a storage drive 2612 used for storing content such as product information and/or gate timing parameters. The components 2602, 2604, 2606, 2608, 2610, and 2612 are interconnected by a data transport system (e.g., a bus) 2614. A power supply unit (PSU) 2616 provides power to components of the system 2600 via a power transport system 2618 (shown with data transport system 2614, although the power and data transport systems may be separate).

It is understood that the system 2600 may be differently configured and that each of the listed components may actually represent several different components. For example, the CPU 2602 may actually represent a multi-processor or a distributed processing system; the memory unit 2604 may include different levels of cache memory, and main memory; the I/O device 2606 may include monitors, keyboards, touchscreens, and the like; the at least one network interface 2608 may include one or more network cards providing one or more wired and/or wireless connections to a network 2620; and the storage drive 2612 may include hard disks and remote storage locations. Therefore, a wide range of flexibility is anticipated in the configuration of the system 2600, which may range from a single physical platform configured primarily for a single user or autonomous operation to a distributed multi-user platform such as a cloud computing system.

The system 2600 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., iOS, Android, RTOS, Blackberry, and/or Windows Phone), personal computers, servers, and other computing platforms depending on the use of the system 2600. In some embodiments, the system 2600 can be a compact system such as a Raspberry Pi running a Linux-based operating system such as Debian. The operating system, as well as other instructions (e.g., for telecommunications and/or other functions provided by the device 2600), may be stored in the memory unit 2604 and executed by the processor 2602. For example, if the system 2600 is, or is part of, the device 2600, the memory unit 2604 may include instructions for performing some or all of the steps, process, and methods described herein.

The network 2620 may be a single network or may represent multiple networks, including networks of different types, whether wireless or wired. For example, the device 2600 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 2600 with external devices.

Although FIG. 26 illustrates one example of electronic device 2600, various changes may be made to FIG. 26. For example, the electronic device 2600 could include any number of each component in any suitable arrangement. In general, computing and communication systems come in a wide variety of configurations, and FIG. 26 does not limit the scope of this disclosure to any particular configuration.

In one example embodiment, a vending machine comprises a chassis, at least one shelf system including a plurality of product rows, a plurality of product gates each coupled to an associated one of the plurality of product rows, a movable stage, a retrieval platform coupled to the movable stage, wherein the retrieval platform is operable to move to accept a product from one of the plurality of product rows, and a vending machine controller coupled to at least one memory. The vending machine controller is configured to determine a product code and a storage location of a selected product for vending, retrieve, from the at least one memory, timing parameters associated with at least one of the product code or the storage location of the selected product, and control one or more timings of one of the plurality of product gates associated with the determined storage location of the selected product, based on the retrieved timing parameters, to release the selected product from the at least one shelf system to the retrieval platform.

In one or more of the above examples, the timing parameters include parameters for a gate opening speed, a gate open duration, and a gate closing speed.

In one or more of the above examples, to control the one or more timings of the one of the plurality of product gates, the vending machine controller is further configured to modulate one or more pulse width modulation (PWM) signals, wherein each of the one or more PWM signals are associated with one of the gate opening speed, the gate open duration, and the gate closing speed.

In one or more of the above examples, the timing parameters associated with the storage location of the selected product are based on dimensions of the at least one shelf system and an angle of one of the plurality of product rows associated with the storage location of the selected product.

In one or more of the above examples, the timing parameters associated with the product code are based on at least one of shape or weight of a product type associated with the product code.

In one or more of the above examples, the vending machine further comprises a pusher plate mounted on a sidewall of at least one product row of the plurality of product rows, wherein the pusher plate is operable to push products in the at least one product row towards an end of the at least one product row.

In one or more of the above examples, the end of the at least one product row is associated with a retrieval location of the retrieval platform.

In one or more of the above examples, the retrieval platform includes a surface disposed at a base of the retrieval platform, and wherein the retrieval platform is operable to rotate in a direction of the at least one shelf system when the movable stage positions the retrieval platform in relation to one of the plurality of product rows.

In one or more of the above examples, each of the plurality of product gates includes a release mechanism operable to release a product from the associated one of the plurality of product rows when, due to the rotation of the retrieval platform, the surface of the retrieval platform depresses the release mechanism.

In one or more of the above examples, an angle of the retrieval platform, when the retrieval platform rotates in the direction of the at least one shelf system, matches an angle of at least one of the plurality of product rows.

In another example embodiment, a method of dispensing a product from a vending machine comprises receiving data on a selected product for vending, determining a product code and a storage location of a selected product for vending, retrieving timing parameters associated with at least one of the product code or the storage location of the selected product, moving a retrieval platform coupled to a moveable stage to a position to accept the selected product from one of a plurality of product rows of at least one shelf system of the vending machine, and controlling one or more timings of one of a plurality of product gates associated with the determined storage location of the selected product, based on the retrieved timing parameters, to release the selected product from the at least one shelf system to the retrieval platform, wherein each of the plurality of product gates are coupled to an associated one of the plurality of product rows.

In one or more of the above examples, the timing parameters include parameters for a gate opening speed, a gate open duration, and a gate closing speed.

In one or more of the above examples, controlling the one or more timings of the one of the plurality of product gates includes modulating one or more pulse width modulation (PWM) signals, wherein each of the one or more PWM signals are associated with one of the gate opening speed, the gate open duration, and the gate closing speed.

In one or more of the above examples, the timing parameters associated with the storage location of the selected product are based on dimensions of the at least one shelf system and an angle of one of the plurality of product rows associated with the storage location of the selected product.

In one or more of the above examples, the timing parameters associated with the product code are based on at least one of shape or weight of a product type associated with the product code.

In one or more of the above examples, the method further comprises pushing, with a pusher plate mounted on a sidewall of at least one product row of the plurality of product rows, products in the at least one product row towards an end of the at least one product row.

In one or more of the above examples, the end of the at least one product row is associated with a retrieval location of the retrieval platform.

In one or more of the above examples, the retrieval platform includes a surface disposed at a base of the retrieval platform, and further comprising rotating the retrieval platform in a direction of the at least one shelf system when the movable stage positions the retrieval platform in the position to accept the selected product.

In one or more of the above examples, the method further comprises depressing, by the surface of the retrieval platform when the retrieval platform rotates, a release mechanism of one of the plurality of product gates to release a product from the associated one of the plurality of product rows.

In one or more of the above examples, an angle of the retrieval platform, when the retrieval platform rotates in the direction of the at least one shelf system, matches an angle of at least one of the plurality of product rows.

In another example embodiment, an operator can take picture of a vending machine product placement after arranging products in product locations using a camera. The camera sends a picture or pictures to a remote computer. The remote computer identifies products with location. The remote computer fetches at least one timing parameter such as a gate opening speed, a gate open duration, and a gate closing speed associated with that particular product and sends those timing parameters to the vending machine.

In one or more of the above examples, the camera sends picture or pictures to the vending machine. The vending machine carries out image processing and identifies product in pictures. The vending machine associates identified product with a particular location. The vending machine queries the remote computer for dispensing parameters. The remote computer sends dispensing parameters to the vending machine. The vending machine updates dispensing parameters for the identified product.

In one or more of the above examples, the vending machine carries out image processing and identifies product in pictures. The vending machine associates identified product with a particular location. The vending machine fetches dispensing parameters for identified product. The vending machine updates dispensing parameters for the identified product.

In one or more of the above examples, a processor enclosed in same enclosure as the camera carries out image processing and identifies product in pictures. The processor enclosed in the same envelope as the camera also associates identified product with a particular location. The processor enclosed in the same envelope as the camera fetches dispensing parameters for the identified product. The processor enclosed in the same envelope as the camera transmits dispensing parameters to the vending machine.

In one or more of the above examples, the operator inserts new dispensing parameters for identified product in the pictures.

In one or more of the above examples, the operator modifies dispensing parameters for identified product in the pictures.

In one or more of the above examples, the remote computer also sends the product location to the vending machine.

In one or more of the above examples, the remote computer can also send timing parameters for all product locations.

In another example embodiment, a camera mounted on X-Y platform can take pictures of vending machine product placement after products the vending machine have been arranged in designated product locations. The vending machine carries out image processing and identifies product in pictures. The vending machine associates identified product with a particular location. The vending machine queries the remote computer for dispensing parameters. The remote computer sends dispensing parameters to the vending machine. The vending machine updates dispensing parameters for the identified product.

In one or more of the above examples, the vending machine sends images to a remote computer for image processing and product identification. The remote computer identifies products with location. The remote computer fetches at least one timing parameter such as a gate opening speed, a gate open duration, and a gate closing speed associated with that particular product and sends those timing parameters to the vending machine.

In another example embodiment, a system comprises a vending machine having a product delivery mechanism operable to retrieve products from a shelf and deposit products into an access port for retrieval, an image capture device operable to capture at least one image of an interior compartment of the vending machine, and a vending machine controller coupled to at least one memory, wherein the vending machine controller is configured to receive, based on an analysis of the at least one image, one or more instructions to update a memory coupled to the vending machine controller, wherein the one or more instructions include at least one of an instruction to update a vertical or horizontal calibration of the product delivery mechanism and an instruction to update product information of one or more products stored in the vending machine.

In another example embodiment, a system comprises a vending machine having a product delivery mechanism operable to retrieve products from a shelf and deposit products into an access port for retrieval, an image capture device operable to capture at least one image of an interior compartment of the vending machine, said image capture device mounted on the product delivery mechanism, a vending machine controller coupled to at least one memory, wherein the vending machine controller is configured to receive, based on an analysis of the at least one image, one or more instructions to update a memory coupled to the vending machine controller, the image capture device to send captured images to a processor, the processor to identify at least a product from the images, the processor to associate the product with at least a location, the processor to retrieve from the at least one memory, timing parameters associated with the product for the associated location, and the processor to provide timing parameters associated with the product to the vending machine controller.

In another example embodiment, a system comprises a vending machine having a product delivery mechanism operable to retrieve products from a shelf and deposit products into an access port for retrieval, an image capture device operable to capture at least one image of an interior compartment of the vending machine, a vending machine controller coupled to at least one memory, wherein the vending machine controller is configured to receive, based on an analysis of the at least one image, one or more instructions to update a memory coupled to the vending machine controller, the image capture device to send captured images to a processor, the processor to identify at least a product from the images, the processor to associate the product with at least a location, the processor to retrieve from the at least one memory, timing parameters associated with the product for the associated location, and the processor to provide timing parameters associated with the product to the vending machine controller.

In another example embodiment, a method of retrieving dispense parameters of products in a vending machine to the vending machine comprises an operator taking an image of at least a product in one of the shelves of the vending machine, associating the product with a location, sending the image of the product and location to the vending machine, a processor identifying at least a product from the images, and retrieving, from the at least one memory, timing parameters associated with the product for the location.

In another example embodiment, a method of providing dispense parameters of products in a vending machine to the vending machine comprises an operator taking an image of at least a product in one of the shelves of the vending machine, a processor identifying at least a product from the images, the processor associating the product with a location, retrieving, from the at least one memory, timing parameters associated with the product for the associated location, and providing timing parameters associated with the product to the vending machine.

In another example embodiment, a system comprises a vending machine including a product delivery platform operable to retrieve products from a shelf and deposit products into an access port for retrieval, an image capture device operable to capture at least one image of an interior compartment of the vending machine, and a vending machine controller coupled to at least one memory, wherein the vending machine controller is configured to receive, based on an image analysis of the at least one image, one or more instructions to update the at least one memory.

In one or more of the above examples, the image capture device is mounted on the product delivery platform.

In one or more of the above examples, the one or more instructions include at least one of an instruction to update a vertical calibration or a horizontal calibration of the product delivery platform and an instruction to update product information of one or more products stored in the vending machine.

In one or more of the above examples, the instruction to update the product information of the one or more products is received in response to the image analysis of the at least one image indicating a change in product placement in the vending machine for at least one product of the one or more products.

In one or more of the above examples, the vending machine further includes a plurality of product gates disposed on the shelf of the vending machine, and wherein the product information includes dispensing parameters for at least one of the plurality of product gates associated with the at least one product.

In one or more of the above examples, the dispensing parameters include a gate opening speed, a gate open duration, and a gate closing speed.

In one or more of the above examples, the instruction to update the vertical calibration or the horizontal calibration of the product delivery platform is received in response to the image analysis of the at least one image indicating an offset of the product delivery platform from a home position of the product delivery platform.

In one or more of the above examples, the instruction to update the vertical calibration or the horizontal calibration of the product delivery platform is provided to correct the offset from the home position.

In one or more of the above examples, the home position of the product delivery platform is determined based on the image analysis of the at least one image indicating a change in position of the product delivery platform in relation to other objects in the vending machine.

In one or more of the above examples, the image capture device is configured to transmit the at least one image to a remote device configured to perform the image analysis, and the vending machine controller is configured to receive the one or more instructions to update the at least one memory from the remote device.

In another example embodiment, a method comprises capturing, by an image capture device, at least one image of an interior compartment of a vending machine, the vending machine including a product delivery platform that retrieves products from a shelf and deposits products into an access port for retrieval, and receiving, by a vending machine controller coupled to at least one memory, one or more instructions to update the at least one memory based on an image analysis of the at least one image.

In one or more of the above examples, the image capture device is mounted on the product delivery platform.

In one or more of the above examples, the one or more instructions include at least one of an instruction to update a vertical calibration or a horizontal calibration of the product delivery platform, and an instruction to update product information of one or more products stored in the vending machine.

In one or more of the above examples, the method further comprises receiving the instruction to update the product information of the one or more products in response to the image analysis of the at least one image indicating a change in product placement in the vending machine for at least one product of the one or more products.

In one or more of the above examples, the vending machine further includes a plurality of product gates disposed on the shelf of the vending machine, and wherein the product information includes dispensing parameters for at least one of the plurality of product gates associated with the at least one product.

In one or more of the above examples, the dispensing parameters include a gate opening speed, a gate open duration, and a gate closing speed.

In one or more of the above examples, the method further comprises receiving the instruction to update the vertical calibration or the horizontal calibration of the product delivery platform in response to the image analysis of the at least one image indicating an offset of the product delivery platform from a home position of the product delivery platform.

In one or more of the above examples, the method further comprises providing the instruction to update the vertical calibration or the horizontal calibration of the product delivery platform to correct the offset from the home position.

In one or more of the above examples, the method further comprises determining the home position of the product delivery platform based on the image analysis of the at least one image indicating a change in position of the product delivery platform in relation to other objects in the vending machine.

In one or more of the above examples, the method further comprises transmitting, by the image capture device, the at least one image to a remote device to perform the image analysis and receiving, by the vending machine controller, the one or more instructions to update the at least one memory from the remote device.

While the present disclosure has described certain embodiments and generally associated methods, alterations and permutations of these embodiments and methods will be apparent to those skilled in the art. Accordingly, the above description of example embodiments does not define or constrain the present disclosure. Other changes, substitutions, and alterations are also possible without departing from the spirit and scope of the present disclosure, as defined by the following claims.

1. A system comprising:
a vending machine including a product delivery platform operable to retrieve products from a shelf and deposit products into an access port for retrieval;
an image capture device operable to capture at least one image of an interior compartment of the vending machine; and
a vending machine controller coupled to at least one memory, wherein the vending machine controller is configured to receive, based on an image analysis of the at least one image, one or more instructions to update the at least one memory.

2. The system of claim 1, wherein the image capture device is mounted on the product delivery platform.

3. The system of claim 1, wherein the one or more instructions include at least one of:
an instruction to update a vertical calibration or a horizontal calibration of the product delivery platform; and
an instruction to update product information of one or more products stored in the vending machine.

4. The system of claim 3, wherein the instruction to update the product information of the one or more products is received in response to the image analysis of the at least one image indicating a change in product placement in the vending machine for at least one product of the one or more products.

5. The system of claim 4, wherein the vending machine further includes a plurality of product gates disposed on the shelf of the vending machine, and wherein the product information includes dispensing parameters for at least one of the plurality of product gates associated with the at least one product.

6. The system of claim 5, wherein the dispensing parameters include a gate opening speed, a gate open duration, and a gate closing speed.

7. The system of claim 3, wherein the instruction to update the vertical calibration or the horizontal calibration of the product delivery platform is received in response to the image analysis of the at least one image indicating an offset of the product delivery platform from a home position of the product delivery platform.

8. The system of claim 7, wherein the instruction to update the vertical calibration or the horizontal calibration of the product delivery platform is provided to correct the offset from the home position.

9. The system of claim 8, wherein the home position of the product delivery platform is determined based on the image analysis of the at least one image indicating a change in position of the product delivery platform in relation to other objects in the vending machine.

10. The system of claim 1, wherein:
the image capture device is configured to transmit the at least one image to a remote device configured to perform the image analysis; and
the vending machine controller is configured to receive the one or more instructions to update the at least one memory from the remote device.

11. A method comprising:
capturing, by an image capture device, at least one image of an interior compartment of a vending machine, the vending machine including a product delivery platform that retrieves products from a shelf and deposits products into an access port for retrieval; and
receiving, by a vending machine controller coupled to at least one memory, one or more instructions to update the at least one memory based on an image analysis of the at least one image.

12. The method of claim 11, wherein the image capture device is mounted on the product delivery platform.

13. The method of claim 11, wherein the one or more instructions include at least one of:
an instruction to update a vertical calibration or a horizontal calibration of the product delivery platform; and
an instruction to update product information of one or more products stored in the vending machine.

14. The method of claim 13, further comprising receiving the instruction to update the product information of the one or more products in response to the image analysis of the at least one image indicating a change in product placement in the vending machine for at least one product of the one or more products.

15. The method of claim 14, wherein the vending machine further includes a plurality of product gates disposed on the shelf of the vending machine, and wherein the product information includes dispensing parameters for at least one of the plurality of product gates associated with the at least one product.

16. The method of claim 15, wherein the dispensing parameters include a gate opening speed, a gate open duration, and a gate closing speed.

17. The method of claim 13, further comprising receiving the instruction to update the vertical calibration or the horizontal calibration of the product delivery platform in response to the image analysis of the at least one image indicating an offset of the product delivery platform from a home position of the product delivery platform.

18. The method of claim 17, further comprising providing the instruction to update the vertical calibration or the horizontal calibration of the product delivery platform to correct the offset from the home position.

19. The method of claim 18, further comprising determining the home position of the product delivery platform based on the image analysis of the at least one image indicating a change in position of the product delivery platform in relation to other objects in the vending machine.

20. The method of claim 11, further comprising:
transmitting, by the image capture device, the at least one image to a remote device to perform the image analysis; and
receiving, by the vending machine controller, the one or more instructions to update the at least one memory from the remote device.
